(19) United States
(12) Patent Application Publication
(10) Pub. No.: US 2026/0065169 A1
(43) Pub. Date: Mar. 5, 2026

(54) INFORMATION TRANSMISSION METHOD AND APPARATUS, MODEL DETERMINING METHOD AND APPARATUS, AND RELATED DEVICE

(71) Applicant: VIVO MOBILE COMMUNICATION CO., LTD., Guangdong (CN)

(72) Inventors: Weiwei CHONG, Guangdong (CN); Xiaobo WU, Guangdong (CN)

(21) Appl. No.: 19/381,390

(22) Filed: Nov. 6, 2025

Related U.S. Application Data
(63) Continuation of application No. PCT/CN2024/090465, filed on Apr. 29, 2024.

(30) Foreign Application Priority Data
May 6, 2023 (CN) 202310510909.0

(51) Int. Cl. G06N 20/00; G06F 21/44

(52) U.S. Cl. CPC G06N 20/00; G06F 21/44

(57) ABSTRACT

This application discloses an information transmission method and apparatus, a model determining method and apparatus, and a related device. The information transmission method in embodiments of this application includes: receiving, by a second device, a first message from a first device, where the first message is used for registering or publishing a first model; and sending, by the second device, a second message to the first device, where the second message is a response message for registering or publishing the first model, the second message carries first information, and the first information includes at least one of the following: first indication information; a security authentication certificate of the first model, or token information indicating that the first model succeeds in security authentication of the second device; model identity information; or version information.

### CROSS-REFERENCE TO RELATED APPLICATIONS

This application is a Bypass continuation application of PCT International Application No. PCT/CN2024/090465 filed on Apr. 29, 2024, which claims priority to Chinese Patent Application No. 202310510909.0, filed in China on May 6, 2023, which are incorporated herein by reference in their entireties.

### TECHNICAL FIELD

This application pertains to the field of communication technologies, and specifically, relates to an information transmission method and apparatus, a model determining method and apparatus, and a related device.

### BACKGROUND

An artificial intelligence (AI) method is introduced into a communication network to improve network communication performance.

A network-side device or a terminal device may perform AI or machine learning (ML) model training based on training data, to obtain a corresponding model applicable to an AI task. The network-side device or the terminal device further sends a trained AI/ML model to another terminal device, so that the another terminal device performs inference based on inference input data of the AI/ML model for an AI task, to obtain inference result data corresponding to a specific AI task.

However, when an AI/ML model trained by the network-side device or specific user equipment (UE) is sent to other UE for use, incompatibility or a security risk may occur. For example, different mobile phone vendors (UE Vendor) have respective optimization methods for communication models. Consequently, an AI/ML model trained by using a mobile phone of one vendor is inapplicable to a mobile phone of another vendor.

### SUMMARY

Embodiments of this application provide an information transmission method and apparatus, a model determining method and apparatus, and a related device, to centrally register or publish, by using a second device, models trained by different device.

According to a first aspect, an information transmission method is provided. The method includes:
receiving, by a second device, a first message from a first device, where the first message is used for registering or publishing a first model; and
sending, by the second device, a second message to the first device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

According to a second aspect, an information transmission method is provided. The method includes:
sending, by a first device, a first message to a second device, where the first message is used for registering or publishing a first model; and
receiving, by the first device, a second message from the second device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

According to a third aspect, an information transmission method is provided. The method includes:
receiving, by a third device, second capability information from a target device, where the second capability information is related to a model supported by the target device; and
sending, by the third device, a fifth message to the target device based on the second capability information, where the fifth message is used for triggering or activating a second model on the target device, and the model supported by the target device includes the second model.

According to a fourth aspect, an information transmission method is provided. The method includes:
receiving, by a target device, third information; and
obtaining, by the target device, a target model based on the third information, where the target model includes at least one first model, and the first model is from a first device and is registered or published by a second device.

According to a fifth aspect, a model determining method is provided. The method includes:
receiving, by a third device, first capability information from a target device, where the first capability information is used for indicating an AI capability of the target device; and
determining, by the third device, a target model based on the first capability information, where the target model includes a model applicable to the target device.

According to a sixth aspect, a model determining method is provided. The method includes:
sending, by a target device, first capability information to a third device, where the first capability information is used for indicating an AI capability of the target device; and
obtaining, by the target device, a target model, where the target model includes a model applicable to the target device.

According to a seventh aspect, a model determining method is provided. The method includes:
obtaining, by a second device, first capability information, where the first capability information is used for indicating an AI capability of a target device; and
determining, by the second device, a target model from a first model based on the first capability information, where the target model includes a model applicable to the target device.

According to an eighth aspect, an information transmission apparatus is provided, including:
a first receiving module, configured to receive a first message from a first device, where the first message is used for registering or publishing a first model; and
a first sending module, configured to send a second message to the first device, where the second message is a response message for registering or publishing the first model, the second message carries first information, and the first information includes at least one of the following:
first indication information, used for indicating whether the first model succeeds in security authentication of a second device;
a security authentication certificate of the first model, or token information indicating that the first model succeeds in security authentication of the second device;
model identity information, allocated by the second device, of the first model; or
version information, allocated by the second device, of the first model.

According to a ninth aspect, an information transmission apparatus is provided, including:
a second sending module, configured to send a first message to a second device, where the first message is used for registering or publishing a first model; and
a second receiving module, configured to receive a second message from the second device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

According to a tenth aspect, an information transmission apparatus is provided, including:
a third receiving module, configured to receive second capability information from a target device, where the second capability information is related to a model supported by the target device; and
a third sending module, configured to send a fifth message to the target device based on the second capability information, where the fifth message is used for triggering or activating a second model on the target device, and the model supported by the target device includes the second model.

According to an eleventh aspect, an information transmission apparatus is provided, including:
a fourth receiving module, configured to receive third information; and
a first obtaining module, configured to obtain a target model based on the third information, where the target model includes at least one first model, and the first model is from a first device and is registered or published by a second device.

According to a twelfth aspect, a model determining apparatus is provided, including:
a fifth receiving module, configured to receive first capability information from a target device, where the first capability information is used for indicating an AI capability of the target device; and
a first determining module, configured to determine a target model based on the first capability information, where the target model includes a model applicable to the target device.

According to a thirteenth aspect, a model determining apparatus is provided, including:
a fifth sending module, configured to send first capability information to a third device, where the first capability information is used for indicating an AI capability of a target device; and
a second obtaining module, configured to obtain a target model, where the target model includes a model applicable to the target device.

According to a fourteenth aspect, a model determining apparatus is provided, including:
a third obtaining module, configured to obtain first capability information, where the first capability information is used for indicating an AI capability of a target device; and
a second determining module, configured to determine a target model from a first model based on the first capability information, where the target model includes a model applicable to the target device.

According to a fifteenth aspect, a communication device is provided, where the communication device includes a processor and a memory, the memory stores a program or instructions capable of running on the processor, and when the program or the instructions are executed by the processor, the steps of the method according to the first aspect, the second aspect, the third aspect, the fourth aspect, the fifth aspect, the sixth aspect, or the seventh aspect are implemented.

According to a sixteenth aspect, a communication device is provided, including a processor and a communication interface.

In a case that the communication device serves as a second device, the communication interface is configured to receive a first message from a first device, where the first message is used for registering or publishing a first model; and the communication interface is further configured to send a second message to the first device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model;
or
in a case that the communication device serves as a second device, the communication interface is configured to obtain first capability information, where the first capability information is used for indicating an AI capability of a target device; and the processor is configured to determine a target model from a first model based on the first capability information, where the target model includes a model applicable to the target device;
or
in a case that the communication device serves a first device, the communication interface is configured to send a first message to a second device, where the first message is used for registering or publishing a first model; and the communication interface is further configured to receive a second message from the second device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model;
or
in a case that the communication device serves as a third device, the communication interface is configured to receive second capability information from a target device, where the second capability information is related to a model supported by the target device; and the communication interface is further configured to send a fifth message to the target device based on the second capability information, where the fifth message is used for triggering or activating a second model on the target device, and the model supported by the target device includes the second model;
or
in a case that the communication device serves as a third device, the communication interface is configured to receive first capability information from a target device, where the first capability information is used for indicating an AI capability of the target device; and the processor is configured to determine a target model based on the first capability information, where the target model includes a model applicable to the target device;
or
in a case that the communication device serves as a target device, the communication interface is configured to receive third information for the target device; and the processor is configured to obtain a target model based on the third information, where the target model includes at least one first model, and the first model is from a first device and is registered or published by a second device;
or

in a case that the communication device serves as a target device, the communication interface is configured to send first capability information to a third device, where the first capability information is used for indicating an AI capability of the target device; and the communication interface is further configured to obtain a target model, where the target model includes a model applicable to the target device.

According to a seventeenth aspect, a readable storage medium is provided, where the readable storage medium stores a program or instructions, and when the program or the instructions are executed by a processor, the steps of the method according to the first aspect are implemented, or the steps of the method according to the second aspect are implemented, or the steps of the method according to the third aspect are implemented, or the steps of the method according to the fourth aspect are implemented, or the steps of the method according to the fifth aspect are implemented, or the steps of the method according to the sixth aspect are implemented, or the steps of the method according to the seventh aspect are implemented.

According to an eighteenth aspect, a wireless communication system is provided, including a first device, a second device, a third device, and a target device, where the first device may be configured to perform the steps of the method according to the second aspect, the second device may be configured to perform the steps of the method according to the first aspect or the seventh aspect, the third device may be configured to perform the steps of the method according to the third aspect or the fifth aspect, and the target device may be configured to perform the steps of the method according to the fourth aspect or the sixth aspect.

According to a nineteenth aspect, a chip is provided, where the chip includes a processor and a communication interface, the communication interface is coupled to the processor, and the processor is configured to run a program or instructions, to implement the method according to the first aspect, the second aspect, the third aspect, the fourth aspect, the fifth aspect, the sixth aspect, or the seventh aspect.

According to a twentieth aspect, a computer program or program product is provided, where the computer program or program product is stored in a storage medium, and the program or program product is executed by at least one processor, to implement the steps of the method according to the first aspect, the second aspect, the third aspect, the fourth aspect, the fifth aspect, the sixth aspect, or the seventh aspect.

### BRIEF DESCRIPTION OF THE DRAWINGS

FIG. 1 is a schematic structural diagram of a wireless communication system to which embodiments of this application are applicable;

FIG. 2 is a flowchart of a first information transmission method according to an embodiment of this application;

FIG. 3 is a flowchart of a second information transmission method according to an embodiment of this application;

FIG. 4 is a flowchart of a third information transmission method according to an embodiment of this application;

FIG. 5 is a flowchart of a fourth information transmission method according to an embodiment of this application;

FIG. 6 is a flowchart of a first model determining method according to an embodiment of this application;

FIG. 7 is a flowchart of a second model determining method according to an embodiment of this application;

FIG. 8 is a flowchart of a third model determining method according to an embodiment of this application;

FIG. 9a is a first diagram of interaction between communication devices according to an embodiment of this application;

FIG. 9b is a second diagram of interaction between communication devices according to an embodiment of this application;

FIG. 9c is a third diagram of interaction between communication devices according to an embodiment of this application;

FIG. 10 is a schematic structural diagram of a first information transmission apparatus according to an embodiment of this application;

FIG. 11 is a schematic structural diagram of a second information transmission apparatus according to an embodiment of this application;

FIG. 12 is a schematic structural diagram of a third information transmission apparatus according to an embodiment of this application;

FIG. 13 is a schematic structural diagram of a fourth information transmission apparatus according to an embodiment of this application;

FIG. 14 is a schematic structural diagram of a first model determining apparatus according to an embodiment of this application;

FIG. 15 is a schematic structural diagram of a second model determining apparatus according to an embodiment of this application;

FIG. 16 is a schematic structural diagram of a third model determining apparatus according to an embodiment of this application;

FIG. 17 is a schematic structural diagram of a communication device according to an embodiment of this application;

FIG. 18 is a schematic structural diagram of a terminal according to an embodiment of this application;

FIG. 19 is a schematic structural diagram of a network-side device according to an embodiment of this application; and

FIG. 20 is a schematic structural diagram of another network-side device according to an embodiment of this application.

### DETAILED DESCRIPTION

The following clearly describes the technical solutions in the embodiments of this application with reference to the accompanying drawings in the embodiments of this application. Clearly, the described embodiments are some but not all of the embodiments of this application.

The terms “first”, “second”, and the like in this application are intended to distinguish between similar objects, but not to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish between objects of a same type, and do not limit a quantity of objects. For example, there may be one or more first objects. In addition, “or” in this application indicates at least one of connected objects. For example, “A or B” covers three solutions: Solution 1: A is included, and B is not included. Solution 2: B is included, and A is not included. Solution 3: Both A and B are included. The character “/” usually indicates an “or” relationship between associated objects.

The term “indication” in this application may be a direct indication (namely, an explicit indication), or may be an indirect indication (namely, an implicit indication). The direct indication may be understood as that a sender explicitly notifies, in a sent indication, a receiver of specific information, an operation that needs to be performed, a request result, or other content. The indirect indication may be understood as that a receiver determines corresponding information based on an indication sent by a sender; or performs determining, and determines, based on a determining result, an operation that needs to be performed, a request result, or the like.

It should be noted that technologies described in the embodiments of this application are not limited to a long term evolution (LTE)/LTE-advanced (LTE-A) system, and may also be applied to other wireless communication systems, such as code division multiple access (CDMA), time division multiple access (TDMA), frequency division multiple access (FDMA), orthogonal frequency division multiple access (OFDMA), single-carrier frequency division multiple access (SC-FDMA), or other systems. The terms “system” and “network” in the embodiments of this application are usually used interchangeably, and the described technology may be applied to the systems and the radio technologies mentioned above, or may be applied to other systems and radio technologies. In the following descriptions, a new radio (NR) system is described for an illustration purpose, and NR terms are used in most of the following descriptions, but these technologies may also be applied to systems other than the NR system, for example, a 6th-generation (6G) communication system.

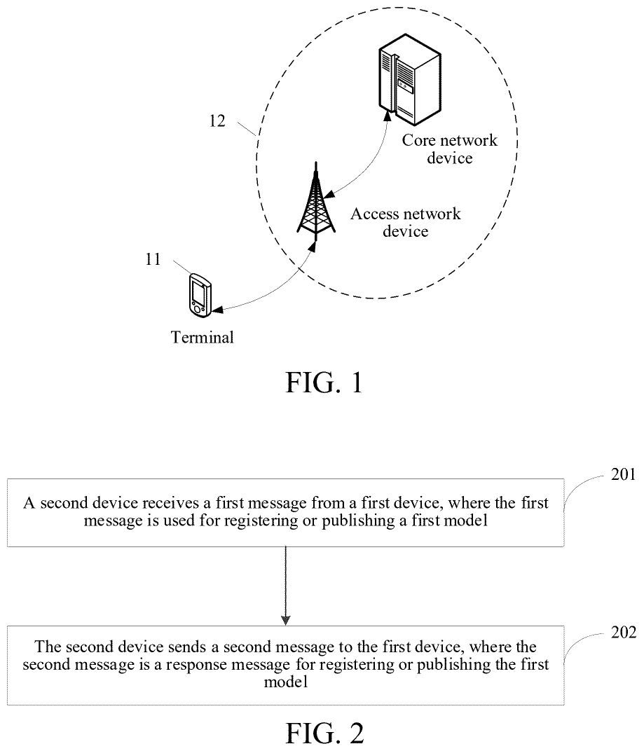

FIG. 1 is a block diagram of a wireless communication system to which embodiments of this application are applicable. The wireless communication system includes a terminal 11 and a network-side device 12. The terminal 11 may be a terminal device such as a mobile phone, a tablet computer, a laptop computer, a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a flight vehicle, an in-vehicle device (VUE), a shipborne device, a pedestrian terminal (PUE), a smart home appliance (a home appliance with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart ankle chain, or the like), a smart wristband, smart clothing, or the like. The in-vehicle device may also be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in the embodiments of this application. The network-side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next-generation NodeB (gNB), a new radio NodeB (NR NodeB), an access point, a relay station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the art. Provided that the same technical effects are achieved, the base station is not limited to a specific technical term. It should be noted that a base station in an NR system is used only as an example for description in the embodiments of this application, but a specific type of the base station is not limited.

The core network device may include but is not limited to at least one of the following: a core network node, a core network function, a location management function (LMF), a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), centralized network configuration (CNC), a network repository function (NRF), a network exposure function (NEF), a local NEF (L-NEF), a binding support function (BSF), an application function (AF), a network data analytics function (NWDAF), and the like. It should be noted that the core network device in the NR system is used only as an example for description in the embodiments of this application, but a specific type of the core network device is not limited. It should be noted that the core network device in the NR system is used only as an example for description in the embodiments of this application, but a specific type of the core network device is not limited.

For ease of understanding an information transmission method and a model determining method provided in the embodiments of this application, the following terms in the embodiments of this application are first described.
(1) Model: The model may include at least one of an AI model and a machine learning (ML) model.
(2) First device: The first device may be a device with a model training function or a device that can provide a model. For example, the first device may include at least one of a third-party service server, a service server in a network, a core network element in a network, a network management system device, a base station device, or a terminal device. A specific type of the first device is not limited herein. For ease of description, in the embodiments of this application, an example in which the first device is a third-party service server, for example, an over the top server (OTT server) that provides a service for a user through the Internet beyond an operator, is usually used for description.
(3) Second device: The second device may be a device with at least one of the following functions:
a model information registration function;
a model information update function;
a model information deletion function;
a model identity allocation function;
a model storage function; or
a model distribution function.

Specifically, the second device may be a model store/model publishing platform deployed by an operator, or the second device may be a model store/model publishing platform deployed by a third party. For example, the second device may be an NEF network element, an analytics data repository function (ADRF) network element, an NRF network element, or a newly defined network element. A specific type of the second device is not limited herein. For ease of description, in the embodiments of this application, an example in which the second device is a model store deployed by an operator is usually used for description.
(4) Third device: The third device is a device for triggering a target device to activate or use a specific model. For example, it is assumed that the target device is user equipment (UE). The third device may be a model management and control device in a RAN or a core network (CN). The model management and control device can trigger activation or use of a corresponding model on the UE based on an actual network environment of the UE. For ease of description, in the embodiments of this application, an example in which the third device is a 3GPP model management and control device is usually used for description. This is not specifically limited herein.

Optionally, at least two of the first device, the second device, and the third device may be physically deployed together. For example, a model may be trained or provided by the second device or the third device. For another example, the third device and the model store/model publishing platform may be physically deployed together. To be specific, the third device and the second device may be located in a same physical device. Certainly, the third device and the model store/model publishing platform may alternatively be independently deployed. For example, a model management and control device in a CN may be an NWDAF network element.
(5) Target device: The target device may be a device that needs to obtain a model, for example, UE or a network-side device.
(6) First model: The first model is a model provided or trained by the first device, and the first model is registered or published by the second device.
(7) Target model: The target model is a model that is obtained by the target device and that is registered or published by the second device.
(8) Second model: The second model is a model that the third device triggers the target device to activate or use, and the second model may be some or all of models in the target model.

There may be one or at least two first models, and there may be one or at least two target models.

It should be noted that, in the related technology, a device for training a model may transmit model file information to a target device, for example, transmit information such as a model file, storage information of the model (an address or a network element identity for storing the model file), a model identity (ID), and a model version ID. The device for training the model and the target device may be devices manufactured by different vendors. In the solution, because devices manufactured by different vendors have respective optimization methods for communication models, when an AI/ML model trained by a device of one vendor is sent to a device of another vendor for use, incompatibility or a security risk may occur. In addition, different vendors (especially third parties) generate communication models by using different methods and also have respective optimization methods for the communication models. For example, management rules for model IDs or version IDs are different. In this case, when an AI/ML model trained by a device of one vendor is sent to a device of another vendor for use, the model may not be effectively scheduled.

However, in the embodiments of this application, the second device centrally manages models from the first device, so that models provided or trained by devices manufactured by different vendors can be centrally registered or published. In this way, another device can select a compatible or secure model based on registration information or publishing information of the model. In addition, model IDs, version IDs, or the like of models from different devices can be centrally managed by using the second device, so that a model can be effectively scheduled based on a unified model ID or version ID.

The following describes in detail an information transmission model, a model determining method, an information transmission apparatus, a model determining apparatus, and a related device provided in the embodiments of this application with reference to the accompanying drawings and by using some embodiments and application scenarios thereof.

FIG. 2 shows an information transmission method according to an embodiment of this application. The method may be performed by a second device. As shown in FIG. 2, the information transmission method may include the following steps:

Step 201: The second device receives a first message from a first device, where the first message is used for registering or publishing a first model.

Step 202: The second device sends a second message to the first device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

In an implementation, after the second device registers the first model from the first device, another device may obtain a model based on registration information. For example, the second device centrally registers and manages first models from a plurality of first devices. In this way, when obtaining a model, the another device may obtain a model based on unified registration information, so that a model can be effectively scheduled between different devices or between devices of different vendors.

In an implementation, after the second device publishes the first model from the first device, another device may obtain a model published by the second device.

Optionally, the second device may perform security verification, for example, network access security authentication, on the first model from the first device, and register or publish the first model in a case that it is determined that the first model succeeds in the security verification.

In this way, security verification may be performed on a registered or published model based on the second device. In this way, when a target device subsequently obtains the registered or published model, a model that fails security verification can be prevented from being directly applied to the target device, to improve security performance of the target device.

In an implementation, before the second device sends the second message to the first device, the method further includes the following step:
The second device determines target information based on the first message, where the target information includes at least one of the following:
the first indication information, where the first indication information indicates whether the first model succeeds in security authentication of the second device;
the security authentication certificate of the first model, or the token information indicating that the first model succeeds in security authentication of the second device;
the model identity information, allocated by the second device, of the first model;
the version information, allocated by the second device, of the first model; or a correspondence between the first model and an activation condition.

In an implementation, the second information may be completely the same as the target information, or the second information may include a part of information in the target information.

In an implementation, in a case that the first model succeeds in security verification of the second device, the security authentication certificate of the first model is generated, or the token information indicating that the first model succeeds in security authentication on the second device is generated.

Optionally, the correspondence between the first model and the activation condition may be used for determining a condition for triggering or activating the first model. For example, it is assumed that the first model succeeds in security authentication of the second device. In this case, the second device publishes the first model, and the target device may obtain the published first model. However, the second device or a third device may determine, based on the correspondence between the first model and the activation condition, a scenario in which the first model is to be activated, so that the target device uses the activated first model to perform model inference.

It should be noted that the second device may independently perform a security authentication operation, or may perform a specific security authentication operation with the help of another network device. A manner of performing, by the second device, a security authentication operation on a model is not limited in this embodiment of this application.

Optionally, the token information indicating that the first model succeeds in security authentication of the second device may be used for a subsequent model user (for example, the target device) to learn that the first model is a model that succeeds in security authentication of the second device.

Optionally, the model identity information, allocated by the second device, of the first model may be understood as follows: The second device centrally manages model IDs of first models, so that first models from different first devices have a unified model ID.

It should be noted that different devices or devices of different vendors may have different allocation rules for model identities, or a same model identity is allocated to models of different devices or devices of different vendors. The second device centrally manages model IDs of models from different devices, so that a model ID allocated by the second device can uniquely identify a model on the second device or within a range of a public land mobile network (PLMN).

Optionally, the version information, allocated by the second device, of the first model may be understood as follows: The second device centrally manages version Ids of first models, so that first models from different first devices have a unified version ID allocation rule.

It should be noted that, different devices or devices of different vendors may have different naming rules for model version information, or duplicate or conflicting model version information is allocated to model versions of different devices or devices of different vendors. The second device centrally manages model version IDs of models from different devices, to ensure that a unified rule is used for model version allocation, and different model versions with a same model ID are uniquely identified.

In addition, the first message may alternatively not carry model version information of the first model. In this case, the second device may alternatively allocate correct version information to the first model based on recorded information.

It should be noted that the second device may independently allocate a model identity or a model version, or may allocate a model identity or a model version with the help of another network device. A manner of allocating, by the second device, model identity or model version information is not limited in this embodiment of this application.

In an optional implementation, the first message carries second information, and the second information includes at least one of the following:
attribute information of the first model;
file information of the first model; or
storage information of the first model.

In an implementation, the attribute information may be attribute information, determined by the first device, of the first model. For example, the attribute information of the first model includes at least one of the following:
version information of the first model;
parameter information of the first model;
an activation condition of the first model;
a function supported by the first model;
producer information of the first model; or
consumer information of the first model.

Optionally, the parameter information of the first model may include a parameter type list (Parameter list) or a parameter value of the first model. For example, the parameter information is used for indicating specific input parameters, output parameters, and weight parameters used in the first model.

Optionally, the activation condition of the first model may also be referred to as a “condition for using the first model” or a “validity/applicable condition”. To be specific, model inference based on the first model can be triggered only when the condition is met. For example, the activation condition of the first model may indicate an environment parameter for activating and using the first model. The environment parameter may include a time parameter (the first model can be activated only at a specific time point or within a specific time period), a location parameter (the first model is activated at a specific tracking area (TA), cell, site, or latitude and longitude location), a channel environment parameter (for example, an antenna port, a carrier frequency, a bandwidth, a subcarrier spacing (SCS), a channel characteristic (a signal-to-noise ratio (SNR), or line-of-sight (LOS) propagation/non-line-of-sight (NLOS) propagation)), or the like.

Optionally, the function supported by the first model may indicate a specific purpose of the first model used for performing inference on a specific task type (identified by a function type or an analytic ID). For example, the purpose may be trajectory prediction, channel state information (CSI) compression or decompression, AI positioning, or beam prediction.

Optionally, the producer information of the first model may indicate a device or a user that provides or trains the first model, for example, may be a producer identity (an ID, a fully qualified domain name (FQDN), or an Internet Protocol (IP) address), a producer vendor (for example, a vendor name/ID), or a producer device batch.

Optionally, the consumer information of the first model may be used for limiting a consumer of a model to a specific range, for example, may be a consumer identity (an ID, an FQDN, an IP address, a type allocation code (TAC), or the like), a consumer vendor (vendor name/ID), or a consumer device batch.

Optionally, the storage information of the first model may include a storage address, a storage location, a storage device, or the like of the file information of the first model. The second device or the target device may obtain file information of a corresponding first model from a corresponding storage address, a corresponding device, or the like based on the storage information.

It should be noted that, for a same first model, attribute information, for example, version information or model representation information, in the first message reported by the first device may be different from attribute information in the first information. To be specific, when registering or publishing the first model, the second device may change at least a part of attribute information of the first model. In other words, the second device determines attribute information of a model to be published or registered.

After the second device registers or publishes the first model, the target device may obtain the registered or published model.

In an optional implementation, the target device may obtain a target model from the first device. In this case, the first message may or may not carry file information or storage information of the target model. For example, the first message carries only a model ID and version information. To be specific, optionally, the file information or the storage information of the target model may not be sent to the second device.

In another optional implementation, the method further includes the following step:
The second device sends third information to the target device, where the third information includes at least one of the following:
file information of the target model;
storage information of the target model;
model identity information, allocated by the second device, of the target model;
version information, allocated by the second device, of the target model;
second indication information, used for indicating that the target model succeeds in security authentication of the second device;
an activation condition of the target model; or
a security authentication certificate of the target model, or token information indicating that the target model succeeds in security authentication of the second device, where
the first model includes the target model.

Optionally, the second device may determine, based on the consumer information in the attribute information, information of the target device, for example, an IP address, an identity, an FQDN, or a TAC of the target device.

Optionally, a manner of sending, by the second device, the third information to the target device may include at least one of the following:
sending the third information through a control plane (CP) signaling path; or
sending the third information through a user plane (UP) path.

Optionally, that the second device sends the third information to the target device may be that the second device directly or indirectly sends the third information to the target device. For example, that the second device indirectly sends the third information to the target device may be that the second device sends the third information to the third device (for example, a model management and control device in a RAN or a CN), and the third device sends the third information to the target device.

Optionally, before the second device sends the third information to the target device, the method further includes the following step:
The second device receives seventh information from the third device, where the seventh information includes the model identity information or the version information of the target model, and the seventh information is used for indicating the second device to send, to the target device, model file information or model storage information corresponding to the model identity information or the version information of the target model.

In an implementation, the seventh information includes the model identity information or the version information of the target model. In this case, the second device may be implicitly indicated, by the model identity information or the version information, to transmit the target model to the target device.

In another implementation, the seventh information may explicitly indicate the second device to transmit the target model to the target device.

In still another implementation, the seventh information includes the model identity information or the version information of the target model and indication information used for indicating the second device to send, to the target device, the model file information or the model storage information corresponding to the target model. In this way, the second device may be indicated, by the indication information, to transmit a model to the target device, and a specific model or specific models transmitted by the second device may be indicated by the model identity information or the version information of the target model.

In this implementation, the third device may determine the target model supported by the target device, and indicate the second device to send, to the target device the model file information or the model storage information corresponding to the target model, so that the target device obtains the target model correspondingly.

Through model registration or publishing and the foregoing process of sending the third information to the target device, a model can be scheduled between different devices, so that the target device obtains a model provided by the first device. Then some or all of models obtained by the target device may be activated.

In an optional implementation, the method further includes the following steps:

The second device receives a third message from the third device, where the third message includes at least one of the following:
model identity information of the target model;
version information of the target model; or
a security authentication certificate of the target model, or token information indicating that the target model succeeds in security authentication of the second device.

The second device sends fourth information to the third device, where the fourth information includes at least one of the following:
third indication information, used for indicating whether the target model succeeds in security authentication of the second device; or
the activation condition of the target model.

The third device is configured to activate a second model of the target device. The second model may be all or a part of models among target models already obtained by the target device. For example, assuming that the target device is user equipment (UE), the third device may be a model management and control device in a RAN or a CN.

In an implementation, the second device receives the third message from the third device, and provides the fourth information for the third device based on the third message, so that the third device can determine, based on the fourth information, whether the target model succeeds in security verification of the second device. In this way, the third device requests the second device to perform re-verification on security authentication information of the target model, to determine whether the target model is secure; or the third device can determine, based on the fourth information, whether a condition for activating the target model is met; or the third device can determine, based on a communication parameter corresponding to the target device and the fourth information, a specific target model to be activated, to be specific, the third device obtains an activation condition of the target model from the second device, for subsequently activating the target model based on an actual network environment.

It should be noted that, before sending the third message to the second device, the third device may receive second capability information from the target device, where the second capability information is related to a model supported by the target device. The model supported by the target device may be a model already obtained by the target device. For example, after registration of the first model is completed, the UE obtains the newly registered model, and then reports, by using the second capability information, a model ID list of the target device. In this case, the third device may correspondingly check the following information: an activation condition of a target model of the target device, whether the target model succeeds in security verification of the second device, and the like.

Optionally, the second capability information may carry at least one of the following:
the version information of the target model; or
the security authentication certificate of the target model, or the token information indicating that the target model succeeds in security authentication of the second device.

In this way, the third device determines, based on the second capability information from the target device, specific models that are supported by the target device or that the target device already has, and therefore sends, to the second device, the third message for requesting to verify the models.

In this implementation, the third device and the second device are independent devices. In another implementation, the third device and the second device may be deployed together. In this case, the second device and the third device are a same device. The second device may determine, based on the second capability information from the target device, whether a condition for activating a target model supported by the target device is met, without exchanging of the third message or the fourth information. Alternatively, the second device determines, based on a communication parameter corresponding to the target device and the fourth information, a specific target model to be activated.

In an optional implementation, the method further includes the following steps:
The second device obtains first capability information, where the first capability information is used for indicating an AI capability of the target device.
The second device determines the target model based on the first capability information and the second information.
In an implementation, the second device may receive the first capability information from the target device.
In another implementation, the second device may obtain the first capability information from the third device. To be specific, the third device first obtains the first capability information of the target device, and then sends the first capability information to the second device.

Optionally, it is assumed that the target device is UE and the third device is a model management and control device in a RAN or a CN. In this case, a manner of sending, by the UE, the first capability information to the third device may include at least one of the following:
the UE may send, through a radio resource control (RRC) layer radio capability (including AI capability information of the UE), the first capability information to the model management and control device in the RAN;
the UE sends the first capability information to an AMF through a 5G mobility management capability (MM capability) (including AI capability information of the UE), and then the AMF sends the first capability information to the model management and control device in the RAN or the CN; or
the UE sends UE model capability reporting information to the model management and control device in the CN, where the UE model capability reporting information includes AI capability information of the UE.

In an implementation, the first capability information includes at least one of the following:
fourth indication information, used for indicating whether the target device supports a model-based AI functionality, for example, whether the target device supports an AI model- based inference function;
an AI functionality type supported by the target device;
functionality identity information of an AI functionality supported by the target device, for example, an AI functionality ID or an analytics ID supported by the target device; or
an applicable condition of each AI functionality supported by the target device.

Optionally, the AI functionality type/ID may be AI positioning, AI trajectory prediction, AI energy saving, or the like.

Optionally, the AI capability information may further include an applicable condition corresponding to each supported AI functionality type/ID. The applicable condition includes applicable time, an applicable service, an applicable location, and the like.

In this implementation, before sending the third information to the target device, the second device further determines, based on the AI capability of the target device, a target model supported by the target device, to deliver only the target model supported by the target device to the target device, to reduce a waste of resources caused by delivering a model that is not supported by the target device to the target device.

It should be noted that, in another optional implementation, the third device may alternatively determine a target model based on the AI capability supported by the target device. In this case, the third device may indicate the second device to provide, to the target device, model file information and storage information of the target model determined by the third device. Alternatively, the third device may obtain model file information and storage information of a registered or published first model from the second device, and after determining a target model based on the AI capability supported by the target device, provide, to the target device, model file information or storage information of the target model determined by the third device.

In the embodiments of this application, a model of the first device is registered by using the second device, to implement centralized management on models trained or provided by different devices; or a model of the first device is published by using the second device, so that the model of the first device can be verified during publishing. In this way, another device can obtain an effective or secure model based on registration information or publishing information.

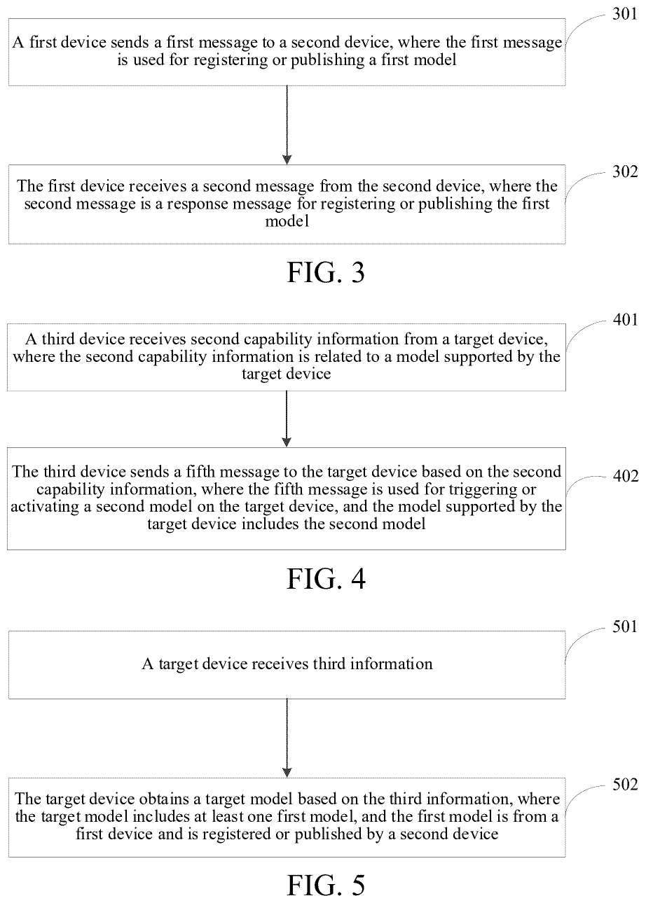

As shown in FIG. 3, a second information transmission method provided in the embodiments of this application may be performed by a first device. The first device may be any device capable of training or providing a model, for example, an AF. The AF may interact with UE through an application layer (for example, an OTT server). As shown in FIG. 3, the second information transmission method may include the following steps:

Step 301: The first device sends a first message to a second device, where the first message is used for registering or publishing a first model.

In an implementation, the first model may be a model trained by the first device.

In a scenario, the model trained by the first device is to be provided to the target device for model inference. For example, it is assumed that the first device is a third-party server (referred to as an AF for short). In this case, the third-party server may train a model for the UE. Specifically, the third-party server collects training data, and performs model training based on the training data and a specific AI model training method, to obtain the model. The collected training data may be from the UE, a base station, a core network, or the AF.

In addition, a type of collected data may be air interface measurement data, specific service data, quality of experience (QoE) data, or the like.

Step 302: The first device receives a second message from the second device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

In this embodiment of this application, meanings and purposes of the first message, the second message, the first device, the second device, the first information, the first indication information, the first model, the security authentication certificate of the first model, the token information indicating that the first model succeeds in security authentication of the second device, the model identity information, and the version information of the first model are the same as the meanings and the purposes of the first message, the second message, the first device, the second device, the first information, the first indication information, the first model, the security authentication certificate of the first model, the token information indicating that the first model succeeds in security authentication of the second device, the model identity information, and the version information of the first model in the method embodiment shown in FIG. 2. For details, refer to the descriptions in the method embodiment shown in FIG. 2. Details are not described herein again.

In an optional implementation, the first message carries second information, and the second information includes at least one of the following:
attribute information of the first model;
file information of the first model; or
storage information of the first model.

In an optional implementation, the attribute information of the first model includes at least one of the following:
version information of the first model;
parameter information of the first model;
an activation condition of the first model;
a function supported by the first model;
producer information of the first model; or
consumer information of the first model.

In an optional implementation, the method further includes the following step:
The first device sends third information to a target device, where the third information includes at least one of the following:
file information of a target model;
storage information of a target model;
model identity information, allocated by the second device, of a target model;
version information, allocated by the second device, of a target model;
second indication information, used for indicating that a target model succeeds in security authentication of the second device;
an activation condition of a target model; or
a security authentication certificate of a target model, or token information indicating that a target model succeeds in security authentication of the second device, where
the first model includes the target model.

In an optional implementation, that the first device sends the third information to the target device includes:
In a case that the first device determines, based on the first information, that the target model succeeds in security authentication of the second device, the first device sends the third information to the target device.
In an optional implementation, before the first device sends the third information to the target device, the method further includes the following step:
The first device receives a fourth message from the target device, where the fourth message is used for requesting a model on the first device, and the model on the first device includes the target model.
In an implementation, after receiving the fourth message, the first device may check whether there is a newly trained or newly generated model. In a case that the first device has a newly trained model, the first device sends sixth indication information to the target device, where the sixth indication information indicates that the first device has a newly trained model. In this way, the target device can obtain the newly trained model from the first device based on the received sixth indication information.

Optionally, that the first device has a newly trained model may be understood as follows: The first device has a model trained after a first moment, and the first moment may be a moment at which a model is transmitted to the target device last time.

For example, the target device periodically requests a newly trained model from the first device. In this way, if the first device trains a model at a moment between T1 and T2, the first device sends the sixth indication information to the target device at T2, to indicate that the first device has a newly trained model after delivering a model to the target device at T1.

For another example, after obtaining a registration response message from the second device, the first device notifies the target device that there is new model file information, and the target device obtains the new model file information from the first device based on the notification. Optionally, if the model file information includes model storage information, the target device downloads a model from an address, a location, or a storage device corresponding to the model storage information. A specific downloading manner is not limited.

In this embodiment of this application, the first model trained or provided by the first device may be centrally registered or published by the second device, to implement unified management or security verification on models from different devices. This achieves beneficial effects same as those of the method embodiment shown in FIG. 2. To avoid repetition, details are not described herein again.

FIG. 4 shows a third information transmission method according to an embodiment of this application. The method is performed by a third device, for example, a model management and control device in a RAN or a CN. As shown in FIG. 4, the third information transmission method may include the following steps:

Step 401: The third device receives second capability information from a target device, where the second capability information is related to a model supported by the target device.

In an implementation, the model supported by the target device may be a model that the target device has.

Step 402: The third device sends a fifth message to the target device based on the second capability information, where the fifth message is used for triggering or activating a second model on the target device, and the model supported by the target device includes the second model.

In an implementation, the model supported by the target device may be the target model shown in FIG. 2, to be specific, a model that is obtained by the target device and that is registered or published by a second device.

It should be noted that meanings of the third device, the target device, and the target model in this embodiment of this application are the same as the meanings of the third device, the target device, and the target model in the method embodiment shown in FIG. 2. Details are not described herein again.

In this embodiment of this application, the third device can trigger or activate the second model on the target device based on the model supported by the target device, so that the target device can perform model inference by using the triggered or activated second model.

In an optional implementation, the second capability information includes at least one of the following:
model identity information of the model supported by the target device, for example, a model ID list;
version information corresponding to the model supported by the target device; or
a security authentication certificate of the model supported by the target device, or token information indicating that the model supported by the target device succeeds in security authentication of the second device.

In an implementation, in a case that the second capability information includes the security authentication certificate of the model supported by the target device, or the token information indicating that the model supported by the target device succeeds in security authentication of the second device, the third device may correspondingly determine that the model supported by the target device succeeds in security verification of the second device, to trigger or activate the model supported by the target device.

In another implementation, in a case that the second capability information does not include the security authentication certificate of the model supported by the target device, or the token information indicating that the model supported by the target device succeeds in security authentication of the second device, the third device may request the second device to verify the model supported by the target device.

For example, the method further includes the following step:
The third device sends a sixth message to the second device, where the sixth message includes at least one of the following:
the model identity information of the model supported by the target device; or
the version information of the model supported by the target device.

The third device receives sixth information from the second device, where the sixth information includes at least one of the following:
fifth indication information, used for indicating whether the model supported by the target device succeeds in security authentication of the second device;
a use condition corresponding to the model identity information or the version information of the model supported by the target device; or
the security authentication certificate of the model supported by the target device, or the token information indicating that the model supported by the target device succeeds in security authentication of the second device.

In an implementation, a function of the sixth message in this embodiment of this application is similar to the function of the third message in the method embodiment shown in FIG. 2. A difference lies in: The third message is used for requesting the second device to verify the target model, and the sixth message is used for requesting the second device to verify the model supported by the target device. Optionally, the model supported by the target device may be the same as the target model in the method embodiment shown in FIG. 2. In this case, the third message is the same as the sixth message. Similarly, the sixth information in this embodiment of this application is the same as or similar to the fourth information in the method embodiment shown in FIG. 2. For descriptions of the sixth message and the sixth information, refer to the descriptions of the third message and the fourth information in the method embodiment shown in FIG. 2. Details are not described herein again.

Optionally, in a case that the sixth information includes the use condition corresponding to the model identity information or the version information of the model supported by the target device, the third device may activate the corresponding model based on the use condition corresponding to the model.

In an optional implementation, the method further includes the following step:
The third device determines the second model based on a communication parameter corresponding to the target device and the second capability information.

In this implementation, that the third device determines the second model based on the communication parameter corresponding to the target device and the second capability information may be as follows: The third device triggers or activates a second model in a case that the communication parameter (for example, a time parameter: the second model can be activated only at a specific time point or within a specific time period; a location parameter: the second model is activated at a specific TA, cell, site, or latitude and longitude location; or a channel environment parameter: an antenna port, a carrier frequency, a bandwidth, an SCS, a channel characteristic (an SNR or LOS/NLOS)) corresponding to the target device meets a use condition of the corresponding second model.

In an optional implementation, that the third device sends a fifth message to the target device based on the second capability information includes:

In a case that it is determined, based on the second capability information, that a current network environment of the target device meets a use condition of the second model, the third device sends a fifth message to the target device, where
the fifth message may be used for triggering or activating the second model, so that the target device performs model inference by using the second model.

Optionally, the fifth message includes at least one of the following:
model identity information of the second model; or
version information of the second model.

Optionally, the determining that a network environment of the target device meets a use condition of the second model includes at least one of the following:
determining that current time matches a time parameter (for example, the second model can be activated only at a specific time point or within a specific time period) in the use condition of the second model;
determining that location information of the target device matches a location parameter (for example, the second model is activated at a specific TA, cell, site, or latitude and longitude location) in the use condition of the second model; or
determining that a channel of the target device matches a channel environment parameter (for example, an antenna port, a carrier frequency, a bandwidth, an SCS, a channel characteristic (an SNR or LOS/NLOS)) in the use condition of the second model.

In an optional implementation, the method further includes the following steps:

The third device receives first capability information from the target device, where the first capability information is used for indicating an AI capability of the target device.

The third device sends the first capability information to the second device, or the third device determines a target model from a first model based on the first capability information, where the target model includes a model applicable to the target device, and the first model is from the first device and is registered or published by the second device.

In an implementation, the third device sends the first capability information to the second device. In this case, the second device determines, based on the first capability information, a model supported by the target device, that is, the target model.

In another implementation, the third device determines, based on the first capability information, a model supported by the target device.

Optionally, the first capability information includes at least one of the following: fourth indication information, used for indicating whether the target device supports a model-based AI functionality;
an AI functionality type supported by the target device;
functionality identity information of an AI functionality supported by the target device; or
an applicable condition of each AI functionality supported by the target device.

In this embodiment of this application, the process of determining, by the third device or the second device based on the first capability information, the model supported by the target device is the same as the process of determining, by the second device based on the first capability information, the model supported by the target device in the method embodiment shown in FIG. 2, and details are not described herein again. In addition, in this embodiment of this application, a model supported by a capability of the target device can also be selected before the target model is delivered to the target device, to reduce a waste of resources caused by delivering, to the target device, a model that is not supported by the capability of the target device.

FIG. 5 is a flowchart of a fourth information transmission method according to an embodiment of this application. The method is performed by a target device, to be specific, a device that needs to schedule a model from another device, for example, UE. As shown in FIG. 5, the fourth information transmission method may include the following steps:

Step 501: The target device receives third information.

Step 502: The target device obtains a target model based on the third information, where the target model includes at least one first model, and the first model is from a first device and is registered or published by a second device.

In an implementation, the target device may receive the third information from the first device.

In another implementation, the target device may receive the third information from the second device.

The third information is related to the target model. For example, the third information includes at least one of the following:
file information of the target model;
storage information of the target model;
model identity information, allocated by a second device, of the target model;
version information, allocated by the second device, of the target model;
second indication information, used for indicating that the target model succeeds in security authentication of the second device;
an activation condition of the target model; or
a security authentication certificate of the target model, or token information indicating that the target model succeeds in security authentication of the second device.

It should be noted that meanings of the target device, the first device, the second device, the target model, the first model, and the third information in this embodiment of this application are the same as the meanings of the target device, the first device, the second device, the target model, the first model, and the third information in the method embodiment shown in FIG. 2. Details are not described herein again.

In this embodiment of this application, the target device may obtain a model that is trained or provided by the first device and that is registered or published by the second device.

In an optional implementation, the method further includes the following steps:

The target device sends second capability information to a third device, where the second capability information is related to a model supported by the target device.

The target device receives a fifth message from the third device, where the fifth message is used for triggering or activating a second model of the target device, and the target model includes the second model.

In an implementation, the model supported by the target device may be a model that the target device has.

It should be noted that meanings of the third device, the second capability information, the fifth message, and the second model in this embodiment of this application are the same as the meanings of the third device, the second capability information, the fifth message, and the second model in the method embodiment shown in FIG. 4. Details are not described herein again.

Optionally, the method further includes the following step:
The target device performs a model inference operation based on the second model.

Optionally, the second capability information includes at least one of the following:
model identity information of the model supported by the target device;
version information corresponding to the model supported by the target device; or
a security authentication certificate of the model supported by the target device, or token information indicating that the model supported by the target device succeeds in security authentication of the second device.

Optionally, the fifth message includes at least one of the following:
model identity information of the second model; or
version information of the second model.

In this implementation, the target device reports models supported by the target device to the third device, so that the third device can correspondingly activate at least one of the models. In this way, the target device can perform a model inference operation based on the activated second model.

In an optional implementation, before the target device receives the third information, the method further includes the following step:
The target device sends first capability information to the third device, where the first capability information is used for indicating an AI capability of the target device.

That the target device receives third information includes:
The target device receives the third information from the third device or the second device, where the third information includes fifth information.

Optionally, content of the fifth information may be the same as content of the third information, and a difference lies in that the fifth information may be determined by the second device for the target device based on the first capability information.

It should be noted that meanings of the first capability information, the AI capability of the target device, and the third information in this embodiment of this application are the same as the meanings of the first capability information, the AI capability of the target device, and the third information in the method embodiments shown in FIG. 2 and FIG. 4. Details are not described herein again.

Optionally, the fifth information includes at least one of the following:
the file information of the target model;
the storage information of the target model;
the model identity information, allocated by the second device, of the target model;
the version information, allocated by the second device, of the target model;
the activation condition of the target model;
the second indication information, used for indicating that the target model succeeds in security authentication of the second device; or
the security authentication certificate of the target model, or token information indicating that the target model succeeds in security authentication of the second device.

In this implementation, the target device reports a supported AI capability, so that the first device or the second device filters registered or published models for the target device, and provides, to the target device, only a target model supported by a capability of the target device.

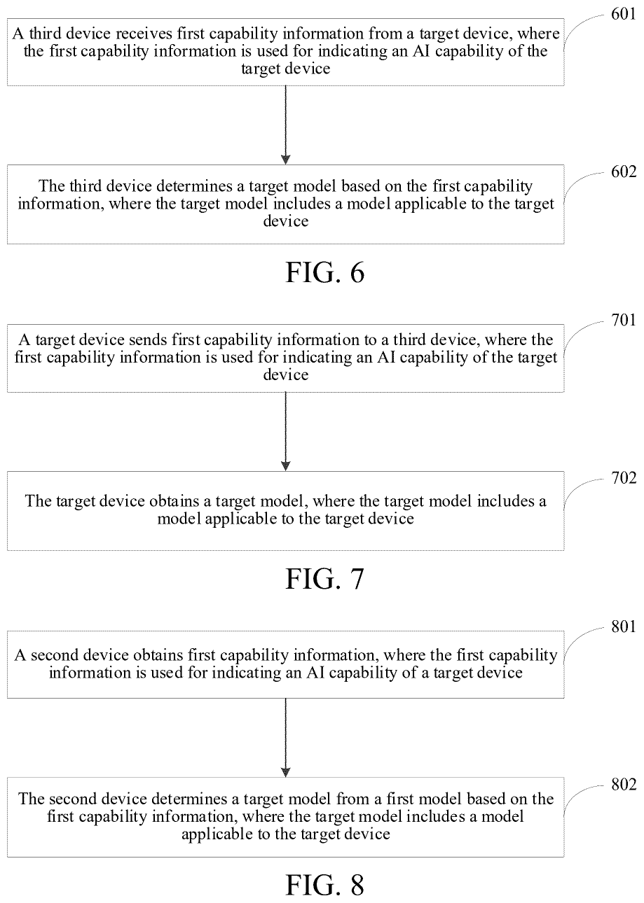

FIG. 6 is a flowchart of a first model determining method according to an embodiment of this application. The method is performed by a third device. As shown in FIG. 6, the first model determining method may include the following steps:

Step 601: The third device receives first capability information from a target device, where the first capability information is used for indicating an AI capability of the target device.

Step 602: The third device determines a target model based on the first capability information, where the target model includes a model applicable to the target device.

In an implementation, the target model may include at least a part of models among first models that are from a first device and that are registered or published by a second device.

In another implementation, the target model may be a model obtained by the target device in another manner. This is not specifically limited herein.

It should be noted that meanings of the first capability information, the AI capability, and the target model in this embodiment of this application are the same as the meanings of the first capability information, the AI capability, and the target model in the method embodiments shown in FIG. 2 to FIG. 5. Details are not described herein again.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

In an optional implementation, that the third device determines a target model based on the first capability information includes at least one of the following:

In a case that the first capability information includes the AI functionality type supported by the target device or the functionality identity information, the third device determines a model corresponding to the AI functionality type or the functionality identity information as the target model. To be specific, if a function supported by a model matches the AI functionality type/ID supported by the target device, the model may be set as a model applicable to the target device.

In a case that the first capability information includes the applicable condition of each AI functionality, the third device determines a model whose activation condition matches the applicable condition of the AI functionality as the target model. To be specific, if a condition (or referred to as an activation condition) under which a model can be used matches the applicable condition included in the first capability information of the target device, the model may be set as a model applicable to the target device.

The third device determines a model whose producer information or consumer information matches a TAC or vendor information of the target device as the target model. To be specific, if consumer information of a model includes the TAC or the vendor information of the target device, the model may be set as a model applicable to the target device.

Optionally, the method further includes the following step:
The third device sends fifth information to the target device, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

In an optional implementation, that the third device determines a target model based on the first capability information includes:
the third device sends the first capability information to the second device;
the third device receives the fifth information from the second device; and
the third device determines the target model based on the fifth information.

In this implementation, the third device forwards the first capability information to the second device, so that the second device correspondingly determines a target model applicable to the target device.

In another optional implementation, after the third device determines the target model based on the first capability information, the method further includes the following step:
The third device sends seventh information to the second device, where the seventh information includes the model identity information or the version information of the target model, and the seventh information is used for indicating the second device to send, to the target device, model file information or model storage information corresponding to the model identity information or the version information of the target model.

In this implementation, the third device determines, based on the first capability information, a target model applicable to the target device, and indicates the second device to send, to the target device, model file information or model storage information corresponding to the target model.

In this embodiment of this application, the third device can filter models based on the AI capability reported by the target device, to deliver, to the target device, only a model supported by a capability of the target device.

FIG. 7 is a flowchart of a second model determining method according to an embodiment of this application. The method is performed by a target device. As shown in FIG. 7, the second model determining method may include the following steps:

Step 701: The target device sends first capability information to a third device, where the first capability information is used for indicating an AI capability of the target device.

Step 702: The target device obtains a target model, where the target model includes a model applicable to the target device.

It should be noted that meanings of the first capability information, the AI capability, and the target model in this embodiment of this application are the same as the meanings of the first capability information, the AI capability, and the target model in the method embodiments shown in FIG. 2 to FIG. 5. Details are not described herein again.

Optionally, that the target device obtains a target model includes:
The target device obtains the target model from the third device, where optionally, the target model is a model provided or trained by a first device.

Optionally, that the target device obtains a target model includes:
The target device obtains the target model from a second device, where a model registered or published by the second device includes the target model.

Optionally, that the target device obtains a target model includes:
The target device receives fifth information, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

In this embodiment of this application, the steps performed by the target device correspond to the steps performed by the third device in the method embodiment shown in FIG. 6, and beneficial effects same as or similar to those of the method embodiment shown in FIG. 6 can be achieved. To avoid repetition, details are not described herein again.

FIG. 8 is a flowchart of a third model determining method according to an embodiment of this application. The method is performed by a second device. As shown in FIG. 8, the third model determining method may include the following steps:

Step 801: The second device obtains first capability information, where the first capability information is used for indicating an AI capability of a target device.

In an implementation, that the second device obtains first capability information includes:
The second device obtains the first capability information from a third device.

For example, the third device receives the first capability information from the target device, and forwards the first capability information to the second device.

In another implementation, that the second device obtains first capability information includes:
The second device obtains the first capability information from the target device.

Step 802: The second device determines a target model from a first model based on the first capability information, where the target model includes a model applicable to the target device.

It should be noted that meanings of the first capability information, the AI capability, and the target model in this embodiment of this application are the same as the meanings of the first capability information, the AI capability, and the target model in the method embodiments shown in FIG. 2 to FIG. 5. Details are not described herein again.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

Optionally, that the second device determines a target model from a first model based on the first capability information includes at least one of the following:
In a case that the first capability information includes the AI functionality type supported by the target device or the functionality identity information, the second device determines a first model corresponding to the AI functionality type or the functionality identity information as the target model.

In a case that the first capability information includes the applicable condition of each AI functionality, the second device determines a first model whose activation condition matches the applicable condition of the AI functionality as the target model.

The second device determines a first model whose producer information or consumer information matches a type allocation code TAC or vendor information of the target device as the target model.

Optionally, the method further includes the following step:
The second device sends fifth information to at least one of the third device and the target device, where the fifth information includes at least one of the following:
file information of the target model;
information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

In an implementation, the second device may pre-obtain the first capability information of the target device. Then, during model registration or publishing, when determining that a model to be registered or published is applicable to the target device, the second device may send the fifth information to the target device.

In another implementation, the second device may send the fifth information to the third device, and the third device forwards the fifth information to the target device. For example, during model registration or publishing, the second device sends, to the third device, model file information of a model to be registered or published. After receiving the first capability information of the target device, the third device selects model file information of a target model applicable to the target device from received model file information of models, and sends the model file information to the target device.

In this embodiment of this application, the steps performed by the target device correspond to the steps performed by the third device in the method embodiment shown in FIG. 6 and the steps performed by the target device in the method embodiment shown in FIG. 7, and beneficial effects same as or similar to those of the method embodiments shown in FIG. 6 and FIG. 7 can be achieved. To avoid repetition, details are not described herein again.

For ease of understanding the information transmission method and the model determining method provided in the embodiments of this application, it is assumed that the first device is an OTT server, the second device is a model store, the third device is a model management and control device in a RAN or a CN, and the target device is UE or another consumer. A process of interaction between the first device, the second device, the third device, and the target device is described by using the following three application scenarios as examples.

Application scenario 1: The OTT server registers model information with the model store, and the UE obtains a model from the OTT server and triggers the model.

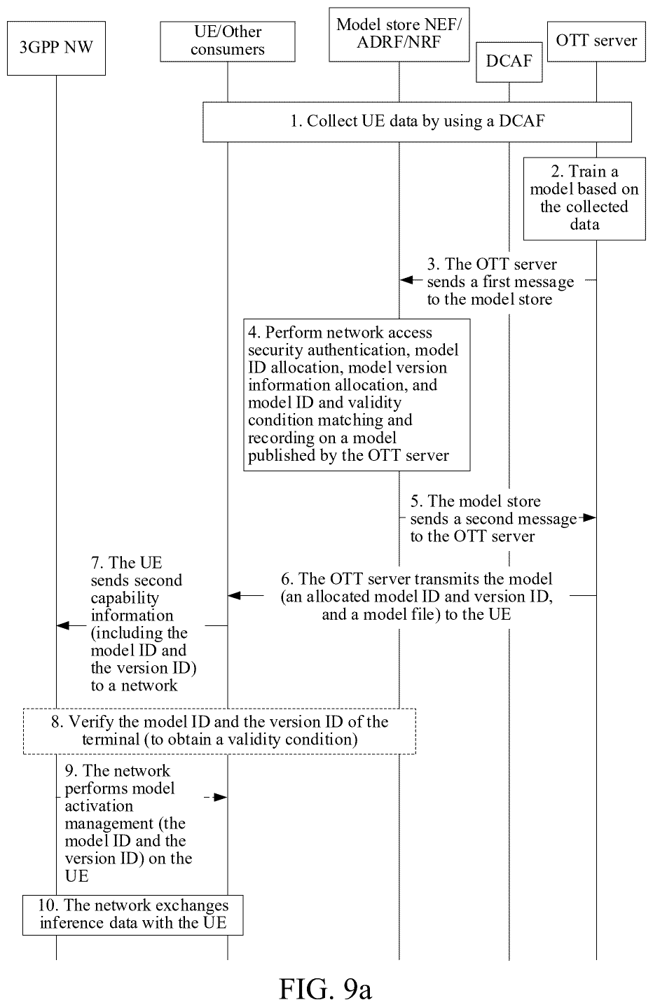

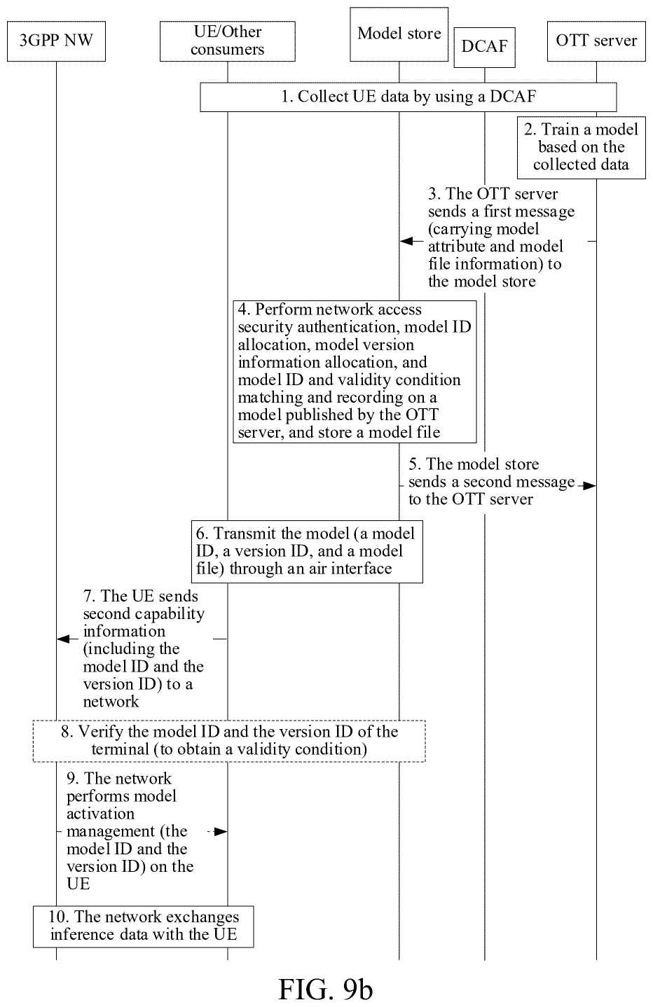

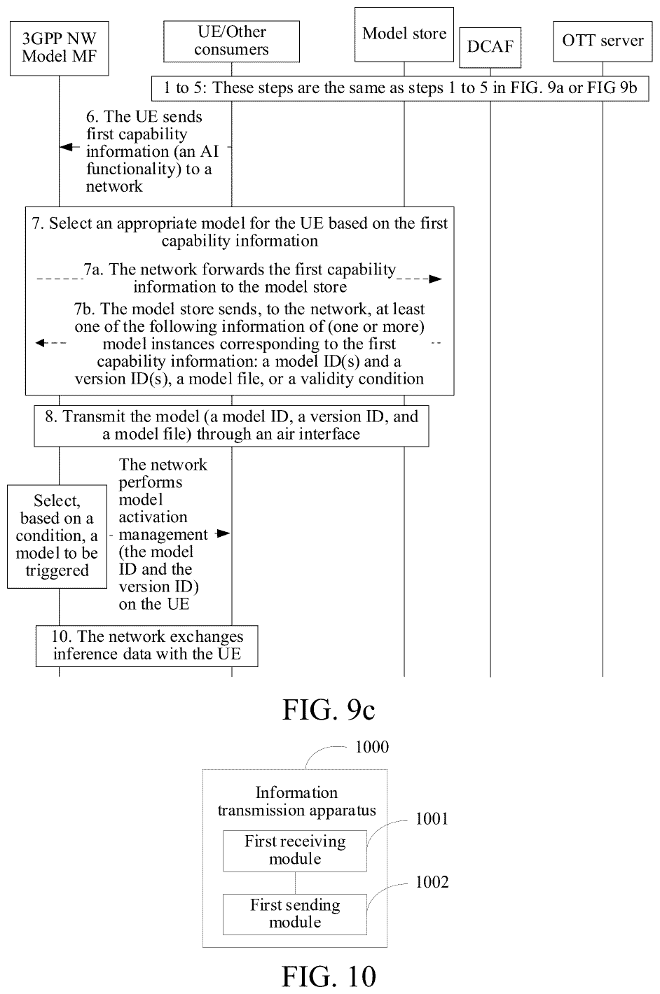

As shown in FIG. 9a, a process of interaction between the OTT server, the model store, the UE, and the model management and control device in the RAN or the CN includes the following steps:
Step 1: Collect UE data by using a data collection application server (DCAF).
Step 2: The OTT server trains a model based on the collected data.
Step 3: The OTT server sends a first message to the model store, to request model registration or publish a model configuration file (carrying a function, a producer, a consumer, a validity condition, and a version).

In step 3, the OTT server registers or publishes related information of a trained model to the model store, and the message includes attribute information of the model.
Step 4: The model store performs network access security authentication, model ID allocation, model version information allocation, and model ID and validity condition matching and recording on the model published by the OTT server.
Step 5: The model store sends a second message (namely, a registration response message) to the OTT server, where the second message carries a model ID and a version ID that are determined during model publishing.
Step 6: The OTT server transmits the model (the allocated model ID and version ID, and a model file) to the UE. Optionally, there is a model indication or request process between step 5 and step 6. For example, the UE requests the model from the OTT server, or the OTT server indicates, to the UE, that there is a new model.

It should be noted that, in this step, the OTT server may transmit model file information to the UE, for example, a model file, or model storage address information (used for indicating a download address, a URL location, a storage device, or the like of the model file to the UE). The model file includes structural information of a model or parameter information of a model. The parameter information includes a parameter type list or a parameter value.

Specifically, the AF further simultaneously sends, to the UE, a model ID+version num corresponding to the model file information, where the model ID is allocated by the model store, and the model version num may be allocated by the model store or allocated by the AF.

A specific manner of pushing includes: The UE periodically queries, from the AF through a request, whether there is new model file information. When the AF has new model file information, the AF notifies the UE, and the UE obtains the new model file information from the AF based on the notification.

Another manner of pushing includes: After obtaining a registration response message from the model store, the AF notifies the UE of new model file information, and the UE obtains the new model file information from the AF based on the notification.

If the model file information includes model storage information, the UE downloads a model from an address, a location, or a storage device corresponding to the model storage information. A specific downloading manner is not limited.
Step 7: The UE sends second capability information (including the model ID and the version ID) to a network. The UE may receive one or more models from the OTT server. In this case, one of the models needs to be activated, and different models may be activated based on different scenarios/functions.
Step 8: Verify the model ID and the version ID of the terminal (to obtain a validity condition).

This step may be verification between the model management and control device in the RAN or the CN and the second device. For example, the model management and control device in the RAN or the CN sends a verification request message to the second device, and the second device feeds back a verification response message to the model management and control device in the RAN or the CN.

Optionally, the verification request message is intended for at least one of the following purposes:
verifying whether the model ID or other information reported by the UE in step 7 succeeds in security verification of the model store; or
obtaining a model use condition corresponding to the model ID and, optionally, the version information.

Correspondingly, the verification response message includes at least one of the following information:
first indication information; or
the model use condition corresponding to the model ID and, optionally, the version information.
Step 9: The model management and control device in the RAN or the CN performs model activation management (the model ID and the version ID) on the UE.

In this step, when determining that an actual network environment meets a use condition of a specific model, the model management and control device in the RAN or the CN sends, to the UE, a message used for activating the model. The message carries:
an ID of the to-be-activated model; and
version information of the to-be-activated model.
Step 10: The network exchanges inference data with the UE.

After the specific model is activated in step 9, the UE collects input information, and output information should be information obtained by the UE through inference by using the model.

Application scenario 2: The OTT server registers model information with the model store, the UE obtains a model from the model store and triggers the model, and the third device and the second device may be deployed together.

As shown in FIG. 9b, a process of interaction between the OTT server, the model store, the UE, and the model management and control device in the RAN or the CN includes the following steps:
Steps 1 to 5 are similar to steps 1 to 5 in the application scenario shown in FIG. 9a, and a difference includes:
In the application scenario shown in FIG. 9b, in step 3, a registration message sent by the OTT server to the model store further includes model file information. In other words, the OTT server also sends the model file information to the model store for security verification or storage. In step 4, an operation of the model store further includes: saving the model file information.
Step 6: The model store sends the model file information obtained in step 3 to the UE.

Optionally, the model store further sends, to the UE, the following information corresponding to the model file information:
model ID information allocated to the model;
model version information;
first indication information, used for indicating that model information of the model has been verified by the model store/platform; and
a security authentication certificate or token information allocated to the model.

The model store may obtain information about target UE, for example, an IP address, an identity, an FQDN, or a TAC of the target UE, based on the consumer information of the model in step 3.

A manner of sending, by the model store, the model file information to the target UE includes at least one of the following:
sending the model file information through a CP plane signaling path; or
sending the model file information through a UP plane data path.

The sending path may further include the model management and control device in the RAN or the CN. In other words, the model store may first send the model file information to the model management and control device in the RAN or the CN, and then the model management and control device in the RAN or the CN sends the model file information to the UE.
Steps 7 to 10 are the same as steps 7 to 10 in the application scenario shown in FIG. 9a. Details are not described herein again.

Application scenario 3: The OTT server registers model information with the model store, and the UE obtains a model from the model store or the model management and control device in the RAN or the CN, and triggers the model.

As shown in FIG. 9c, a process of interaction between the OTT server, the model store, the UE, and the model management and control device in the RAN or the CN includes the following steps:
Steps 1 to 5 are the same as steps 1 to 5 in the application scenario shown in FIG. 9a or FIG. 9b. Details are not described herein again.
Step 6: The UE sends first capability information of the UE to the model management and control device in the RAN or the CN.
Step 7: The model management and control device in the RAN or the CN selects an appropriate model for the UE based on the first capability information.

Specifically, if the network (the model management and control device in the RAN or the CN) and the model store are deployed separately, the following step 7a and step 7b are performed. If the network and the model store are deployed together, step 7a and step 7b do not need to be performed.
Step 7a: The model management and control device in the RAN or the CN forwards the first capability information to the model store.
Step 7b: The model store sends, to the model management and control device in the RAN or the CN, at least one of the following information of (one or more) model instances corresponding to the first capability information:
a model ID;
version information;
model file information;
a use condition;
first indication information, used for indicating that model information of the model has been verified by the model store/platform; or
a security authentication certificate or token information allocated to the model.

It should be noted that, the model file information may be sent to the model management and control device in the RAN or the CN in this step, and subsequently forwarded to the UE by the model management and control device. In another method, the model file information may not be sent to the model management and control device in the RAN or the CN. To be specific, in step 7b, only model-related attribute information is sent to the model management and control device, and subsequently, the UE directly obtains the model file information from the model store.

Before step 7b, the model store needs to determine, based on the first capability information of the UE, a model to which the AI functionality type/ID is applicable.
Step 8: The model management and control device or the model store sends, to the UE, at least one of the following information of (one or more) selected model instances:
a model ID;
version information;
model file information;
a use condition;
first indication information, used for indicating that model information of the model has been verified by the model store/platform; or
a security authentication certificate or token information allocated to the model.

It should be noted that, if a model management and control device or the model store are deployed separately, the foregoing information may be sent in the following two manners:

The model management and control device sends the foregoing information to the UE, where the model management and control device first obtains the foregoing information from the model store.

The model store sends the foregoing information, where optionally, the model store obtains information, such as an identity, an address, and an FQDN, of the UE from the model management and control device in step 7a.
Steps 9 and 10 are the same as steps 9 and 10 in the application scenario 1.

The information transmission method provided in the embodiments of this application may be performed by an information transmission apparatus. In the embodiments of this application, an information transmission apparatus provided in the embodiments of this application is described by using an example in which the information transmission apparatus performs the information transmission apparatus.

Refer to FIG. 10. An information transmission apparatus 1000 provided in an embodiment of this application may be an apparatus in a second device.

As shown in FIG. 10, the information transmission apparatus 1000 may include the following modules:
a first receiving module 1001, configured to receive a first message from a first device, where the first message is used for registering or publishing a first model; and
a first sending module 1002, configured to send a second message to the first device, where the second message is a response message for registering or publishing the first model, the second message carries first information, and the first information includes at least one of the following:
first indication information, used for indicating whether the first model succeeds in security authentication of a second device;
a security authentication certificate of the first model, or token information indicating that the first model succeeds in security authentication of the second device;
model identity information, allocated by the second device, of the first model; or
version information, allocated by the second device, of the first model.

Optionally, the first message carries second information, and the second information includes at least one of the following:
attribute information of the first model;
file information of the first model; or
storage information of the first model.

Optionally, the attribute information of the first model includes at least one of the following:
version information of the first model;
parameter information of the first model;
an activation condition of the first model;
a function supported by the first model;
producer information of the first model; or
consumer information of the first model.

Optionally, the information transmission apparatus 1000 further includes:
a sixth sending module, configured to send third information to a target device, where the third information includes at least one of the following:
file information of a target model;
storage information of a target model;
model identity information, allocated by the second device, of a target model;
version information, allocated by the second device, of a target model;
second indication information, used for indicating that a target model succeeds in security authentication of the second device;
an activation condition of a target model; or
a security authentication certificate of a target model, or token information indicating that a target model succeeds in security authentication of the second device, where the first model includes the target model.

Optionally, the information transmission apparatus 1000 further includes:
a sixth receiving module, configured to receive a third message from the third device, where the third message includes at least one of the following:
model identity information of the target model;
version information of the target model; or
a security authentication certificate of the target model, or token information indicating that the target model succeeds in security authentication of the second device; and
a seventh sending module, configured to send fourth information to the third device, where the fourth information includes at least one of the following:
third indication information, used for indicating whether the target model succeeds in security authentication of the second device; or
the activation condition of the target model.

Optionally, the information transmission apparatus 1000 further includes:
a fourth obtaining module, configured to obtain first capability information, where the first capability information is used for indicating an AI capability of the target device; and
a third determining module, configured to determine the target model based on the first capability information and the second information.

Optionally, the fourth obtaining module is specifically configured to:
obtain the first capability information from the third device.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

Optionally, the information transmission apparatus 1000 further includes:
a seventh receiving module, configured to receive seventh information from the third device, where the seventh information includes the model identity information or the version information of the target model, and the seventh information is used for indicating the second device to send, to the target device, model file information or model storage information corresponding to the model identity information or the version information of the target model.

Optionally, the first device includes at least one of a third-party service server, a service server in a network, a core network element in a network, a network management system device, a base station device, or a terminal device; or
the second device includes a model publishing platform; or
the third device includes a model management and control device; or
the target device includes at least one of a network-side device and a terminal device.

The information transmission apparatus 1000 provided in this embodiment of this application is capable of implementing the processes implemented in the method embodiment shown in FIG. 2, with the same technical effects achieved. To avoid repetition, details are not described herein again.

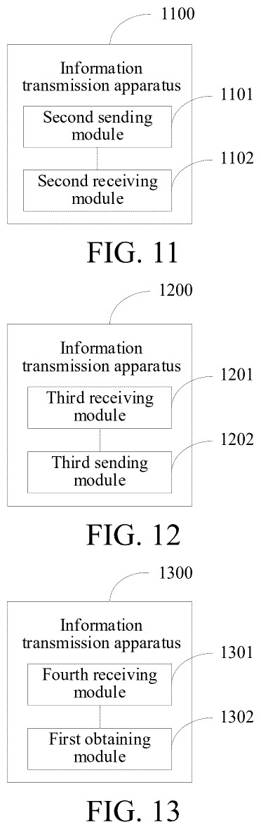

Refer to FIG. 11. An information transmission apparatus 1100 provided in an embodiment of this application may be an apparatus in a first device.

As shown in FIG. 11, the information transmission apparatus 1100 may include the following modules:
a second sending module 1101, configured to send a first message to a second device, where the first message is used for registering or publishing a first model; and
a second receiving module 1102, configured to receive a second message from the second device, where the second message is a response message for registering or publishing the first model, the second message carries first information, and the first information includes at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

Optionally, the first message carries second information, and the second information includes at least one of the following:
attribute information of the first model;
file information of the first model; or
storage information of the first model.

Optionally, the attribute information of the first model includes at least one of the following:
version information of the first model;
parameter information of the first model;
an activation condition of the first model;
a function supported by the first model;
producer information of the first model; or
consumer information of the first model.

Optionally, the information transmission apparatus 1100 further includes:
an eighth sending module, configured to send third information to a target device, where the third information includes at least one of the following:
file information of a target model;
storage information of a target model;
model identity information, allocated by the second device, of a target model;
version information, allocated by the second device, of a target model;
second indication information, used for indicating that a target model succeeds in security authentication of the second device;
an activation condition of a target model; or
a security authentication certificate of a target model, or token information indicating that a target model succeeds in security authentication of the second device, where
the first model includes the target model.

Optionally, the eighth sending module is specifically configured to:
In a case that the first device determines, based on the first information, that the target model succeeds in security authentication of the second device, send the third information to the target device.

Optionally, the information transmission apparatus 1100 further includes:
an eighth receiving module, configured to receive a fourth message from the target device, where the fourth message is used for requesting a model on the first device, and the model on the first device includes the target model.

The information transmission apparatus 1100 provided in this embodiment of this application is capable of implementing the processes implemented in the method embodiment shown in FIG. 3, with the same technical effects achieved. To avoid repetition, details are not described herein again.

Refer to FIG. 12. An information transmission apparatus 1200 provided in an embodiment of this application may be an apparatus in a third device.

As shown in FIG. 12, the information transmission apparatus 1200 may include the following modules:
a third receiving module 1201, configured to receive second capability information from a target device, where the second capability information is related to a model supported by the target device; and
a third sending module 1202, configured to send a fifth message to the target device based on the second capability information, where the fifth message is used for triggering or activating a second model on the target device, and the model supported by the target device includes the second model.

Optionally, the second capability information includes at least one of the following:
model identity information of the model supported by the target device;
version information corresponding to the model supported by the target device; or
a security authentication certificate of the model supported by the target device, or token information indicating that the model supported by the target device succeeds in security authentication of the second device.

Optionally, the information transmission apparatus 1200 further includes:
a fourth determining module, configured to determine the second model based on a communication parameter corresponding to the target device and the second capability information.

Optionally, the information transmission apparatus 1200 further includes:
a ninth sending module, configured to send a sixth message to the second device, where the sixth message includes at least one of the following:
the model identity information of the model supported by the target device; or
the version information of the model supported by the target device; and
a ninth receiving module, configured to receive sixth information from the second device, where the sixth information includes at least one of the following:
fifth indication information, used for indicating whether the model supported by the target device succeeds in security authentication of the second device;
a use condition corresponding to the model identity information or the version information of the model supported by the target device; or
the security authentication certificate of the model supported by the target device, or the token information indicating that the model supported by the target device succeeds in security authentication of the second device.

Optionally, the third sending module 1202 is specifically configured to:
in a case that it is determined, based on the second capability information, that a network environment of the target device meets a use condition of the second model, send a fifth message to the target device.

Optionally, the determining that a network environment of the target device meets a use condition of the second model includes at least one of the following:
determining that current time matches a time parameter in the use condition of the second model;
determining that location information of the target device matches a location parameter in the use condition of the second model; or
determining that a channel of the target device matches a channel environment parameter in the use condition of the second model.

Optionally, the fifth message includes at least one of the following:
model identity information of the second model; or
version information of the second model.

Optionally, the information transmission apparatus 1200 further includes:
a tenth receiving module, configured to receive first capability information from the target device, where the first capability information is used for indicating an AI capability of the target device; and
a tenth sending module, configured to send the first capability information to the second device, or determine, for the third device, a target model from a first model based on the first capability information, where the target model includes a model applicable to the target device, and the first model is from the first device and is registered or published by the second device.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

The information transmission apparatus 1200 provided in this embodiment of this application is capable of implementing the processes implemented in the method embodiment shown in FIG. 4, with the same technical effects achieved. To avoid repetition, details are not described herein again.

Refer to FIG. 13. An information transmission apparatus 1300 provided in an embodiment of this application may be an apparatus in a target device.

As shown in FIG. 13, the information transmission apparatus 1300 may include the following modules:
a fourth receiving module 1301, configured to receive third information; and
a first obtaining module 1302, configured to obtain a target model based on the third information, where the target model includes at least one first model, and the first model is from a first device and is registered or published by a second device.

Optionally, the third information includes at least one of the following:
file information of the target model;
storage information of the target model;
model identity information, allocated by the second device, of the target model;
version information, allocated by the second device, of the target model;
second indication information, used for indicating that the target model succeeds in security authentication of the second device;
an activation condition of the target model; or
a security authentication certificate of the target model, or token information indicating that the target model succeeds in security authentication of the second device.

Optionally, the information transmission apparatus 1300 further includes:
an eleventh sending module, configured to send second capability information to a third device, where the second capability information is related to a model supported by the target device; and
an eleventh receiving module, configured to receive a fifth message from the third device, where the fifth message is used for triggering or activating a second model of the target device, and the target model includes the second model.

Optionally, the information transmission apparatus 1300 further includes:
an operation module, configured to perform a model inference operation based on the second model.

Optionally, the second capability information includes at least one of the following:
model identity information of the model supported by the target device;
version information corresponding to the model supported by the target device; or
a security authentication certificate of the model supported by the target device, or token information indicating that the model supported by the target device succeeds in security authentication of the second device.

Optionally, the fifth message includes at least one of the following:
model identity information of the second model; or
version information of the second model.

Optionally, the fourth receiving module 1301 is specifically configured to:
receive third information from the first device or the second device.

Optionally, the information transmission apparatus 1300 further includes:
a twelfth sending module, configured to send first capability information to the third device, where the first capability information is used for indicating an AI capability of the target device.

The fourth receiving module 1301 is specifically configured to:
receive the third information from the third device or the second device, where the third information includes fifth information.

Optionally, the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

The information transmission apparatus 1300 provided in this embodiment of this application is capable of implementing the processes implemented in the method embodiment shown in FIG. 5, with the same technical effects achieved. To avoid repetition, details are not described herein again.

The model determining method provided in the embodiments of this application may be performed by a model determining apparatus. In the embodiments of this application, a model determining apparatus provided in the embodiments of this application is described by using an example in which the model determining apparatus performs the model determining method.

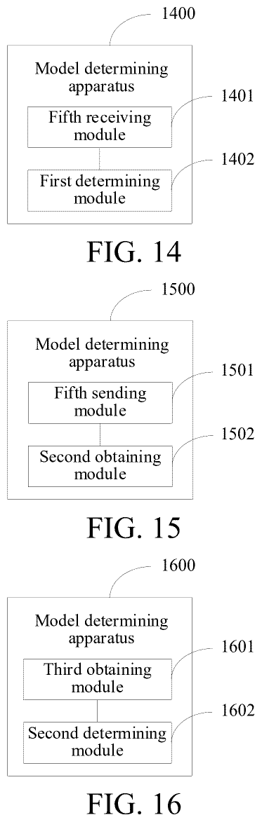

Refer to FIG. 14. A model determining apparatus 1400 provided in an embodiment of this application may be an apparatus in a third device.

As shown in FIG. 14, the model determining apparatus 1400 may include the following modules:
a fifth receiving module 1401, configured to receive first capability information from a target device, where the first capability information is used for indicating an AI capability of the target device; and
a first determining module 1402, configured to determine a target model based on the first capability information, where the target model includes a model applicable to the target device.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

Optionally, the first determining module 1402 is specifically configured to perform at least one of the following:
in a case that the first capability information includes the AI functionality type supported by the target device or the functionality identity information, determining a model corresponding to the AI functionality type or the functionality identity information as the target model;
in a case that the first capability information includes the applicable condition of each AI functionality, determining a model whose activation condition matches the applicable condition of the AI functionality as the target model; or
determining a model whose producer information or consumer information matches a type allocation code TAC or vendor information of the target device as the target model.

Optionally, the model determining apparatus 1400 further includes:
a thirteenth sending module, configured to send fifth information to the target device, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

Optionally, the first determining module 1402 includes:
a first sending unit, configured to send the first capability information to the second device;
a first receiving unit, configured to receive the fifth information from the second device; and
a first determining unit, configured to determine the target model based on the fifth information.

Optionally, the model determining apparatus 1400 further includes:
a fourteenth sending module, configured to send seventh information to the second device, where the seventh information includes the model identity information or the version information of the target model, and the seventh information is used for indicating the second device to send, to the target device, model file information or model storage information corresponding to the model identity information or the version information of the target model.

The model determining apparatus 1400 provided in this embodiment of this application is capable of implementing the processes implemented in the method embodiment shown in FIG. 6, with the same technical effects achieved. To avoid repetition, details are not described herein again.

Refer to FIG. 15. A model determining apparatus 1500 provided in an embodiment of this application may be an apparatus in a target device.

As shown in FIG. 15, the model determining apparatus 1500 may include the following modules:
a fifth sending module 1501, configured to send first capability information to a third device, where the first capability information is used for indicating an AI capability of a target device; and
a second obtaining module 1502, configured to obtain a target model, where the target model includes a model applicable to the target device.

Optionally, the second obtaining module 1502 is specifically configured to:
obtain the target model from the third device.

Optionally, the second obtaining module 1502 is specifically configured to:
obtain the target model from a second device, where a model registered or published by the second device includes the target model.

Optionally, the second obtaining module 1502 is specifically configured to receive fifth information, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

Optionally, the first capability information includes at least one of the following:
fourth indication information, used for indicating whether the target device supports a model-based AI functionality;
an AI functionality type supported by the target device;
functionality identity information of an AI functionality supported by the target device; or an applicable condition of each AI functionality supported by the target device.

The model determining apparatus 1500 provided in this embodiment of this application is capable of implementing the processes implemented in the method embodiment shown in FIG. 7, with the same technical effects achieved. To avoid repetition, details are not described herein again.

Refer to FIG. 16. A model determining apparatus 1600 provided in an embodiment of this application may be an apparatus in a second device.

As shown in FIG. 16, the model determining apparatus 1600 may include the following modules:
a third obtaining module 1601, configured to obtain first capability information, where the first capability information is used for indicating an AI capability of a target device; and
a second determining module 1602, configured to determine a target model from a first model based on the first capability information, where the target model includes a model applicable to the target device.

Optionally, the first capability information includes at least one of the following:
indication information, used for indicating whether the target device supports a model-based AI functionality;
an AI functionality type supported by the target device;
functionality identity information of an AI functionality supported by the target device; or
an applicable condition of each AI functionality supported by the target device.

Optionally, the second determining module 1602 is specifically configured to perform at least one of the following:
in a case that the first capability information includes the AI functionality type supported by the target device or the functionality identity information, determining a first model corresponding to the AI functionality type or the functionality identity information as the target model;
in a case that the first capability information includes the applicable condition of each AI functionality, determining a first model whose activation condition matches the applicable condition of the AI functionality as the target model; or
determining a first model whose producer information or consumer information matches a type allocation code TAC or vendor information of the target device as the target model.

Optionally, the third obtaining module 1601 is specifically configured to:
obtain the first capability information from a third device.

Optionally, the model determining apparatus 1600 further includes:
a fifteenth sending module, configured to send fifth information to at least one of the third device and the target device, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

The model determining apparatus 1600 provided in this embodiment of this application is capable of implementing the processes implemented in the method embodiment shown in FIG. 8, with the same technical effects achieved. To avoid repetition, details are not described herein again.

The information transmission apparatus or the model determining apparatus in the embodiments of this application may be an electronic device, for example, an electronic device with an operating system; or may be a component in an electronic device, for example, an integrated circuit or a chip. The electronic device may be a terminal or a network-side device. For example, the terminal may include but is not limited to the aforementioned types of the terminal 11, and the network-side device includes but is not limited to the aforementioned types of the access network device or the core network device. This is not specifically limited in the embodiments of this application.

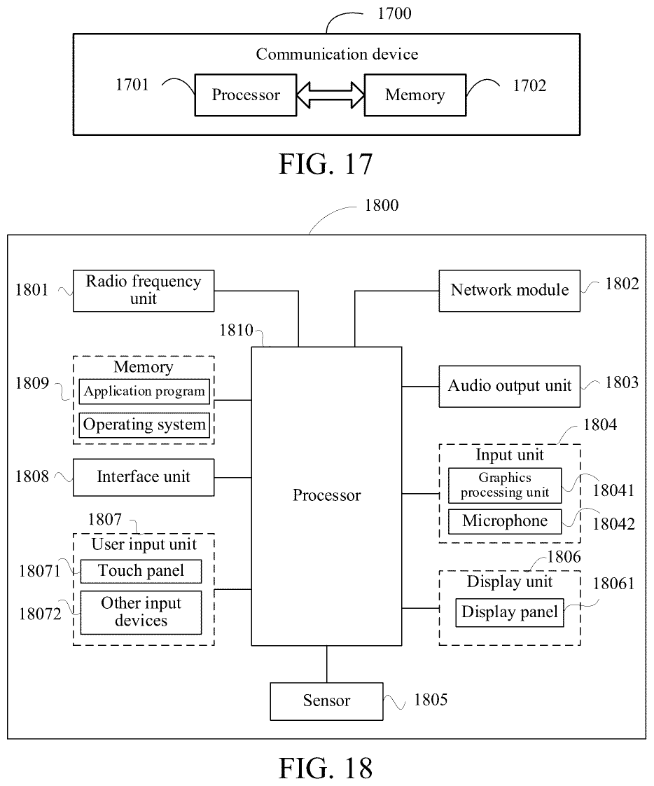

As shown in FIG. 17, an embodiment of this application further provides a communication device 1700, including a processor 1701 and a memory 1702. The memory 1702 stores a program or instructions capable of running on the processor 1701. When the program or the instructions are executed by the processor 1701, the steps in the embodiments of the information transmission method or the model determining method are implemented, with the same technical effects achieved. To avoid repetition, details are not described herein again.

An embodiment of this application further provides a terminal, including a processor and a communication interface. The communication interface is coupled to the processor, and the processor is configured to run a program or instructions to implement the steps in the method embodiment shown in FIG. 5 or FIG. 7. The terminal embodiment corresponds to the foregoing terminal-side method embodiment, and all implementation processes and implementations of the foregoing method embodiment are applicable to the terminal embodiment, with the same technical effects achieved. Specifically, FIG. 18 is a schematic diagram of a hardware structure of a terminal for implementing the embodiments of this application.

The terminal 1800 includes but is not limited to at least some of components such as a radio frequency unit 1801, a network module 1802, an audio output unit 1803, an input unit 1804, a sensor 1805, a display unit 1806, a user input unit 1807, an interface unit 1808, a memory 1809, and a processor 1810.

A person skilled in the art can understand that the terminal 1800 may further include a power supply (for example, a battery) that supplies power to each component. The power supply may be logically connected to the processor 1810 through a power management system, so that functions such as charging management, discharging management, and power consumption management are implemented through the power management system. The terminal structure shown in FIG. 18 does not constitute a limitation on the terminal. The terminal may include more or fewer components than those shown in the figure, or some components may be combined, or different component arrangements may be used. Details are not described herein again.

It should be understood that, in this embodiment of this application, the input unit 1804 may include a graphics processing unit (GPU) 18041 and a microphone 18042. The graphics processing unit 18041 processes image data of a static picture or a video that is obtained by an image capture apparatus (for example, a camera) in a video capture mode or an image capture mode. The display unit 1806 may include a display panel 18061. The display panel 18061 may be configured in a form of a liquid crystal display, an organic light-emitting diode, or the like. The user input unit 1807 includes at least one of a touch panel 18071 and other input devices 18072. The touch panel 18071 is also referred to as a touchscreen. The touch panel 18071 may include two parts: a touch detection apparatus and a touch controller. The other input devices 18072 may include but are not limited to a physical keyboard, a function button (such as a volume control button or an on/off button), a trackball, a mouse, and a joystick. Details are not described herein.

In this embodiment of this application, after receiving downlink data from a network-side device, the radio frequency unit 1801 may transmit the downlink data to the processor 1810 for processing. In addition, the radio frequency unit 1801 may send uplink data to the network-side device. Usually, the radio frequency unit 1801 includes but is not limited to an antenna, an amplifier, a transceiver, a coupler, a low noise amplifier, a duplexer, and the like.

The memory 1809 may be configured to store software programs or instructions and various data. The memory 1809 may mainly include a first storage area for storing a program or instructions and a second storage area for storing data. The first storage area may store an operating system, an application or instructions required by at least one function (for example, an audio play function or an image play function), and the like. In addition, the memory 1809 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), or a direct rambus random access memory (DRRAM). The memory 1809 in this embodiment of this application includes but is not limited to these and any other suitable types of memories.

The processor 1810 may include one or more processing units. Optionally, the processor 1810 integrates an application processor and a modem processor. The application processor mainly processes operations involving an operating system, a user interface, an application, and the like. The modem processor mainly processes a wireless communication signal, and is, for example, a baseband processor. It can be understood that the modem processor may alternatively not be integrated in the processor 1810.

In an implementation, the radio frequency unit 1801 is configured to receive third information; and
the processor 1810 is configured to obtain a target model based on the third information, where the target model includes at least one first model, and the first model is from a first device and is registered or published by a second device.

Optionally, the third information includes at least one of the following:
file information of the target model;
storage information of the target model;
model identity information, allocated by a second device, of the target model;
version information, allocated by the second device, of the target model;
second indication information, used for indicating that the target model succeeds in security authentication of the second device;
an activation condition of the target model; or
a security authentication certificate of the target model, or token information indicating that the target model succeeds in security authentication of the second device.

Optionally, the radio frequency unit 1801 is further configured to send second capability information to a third device, where the second capability information is related to a model supported by the target device; and
the radio frequency unit 1801 is further configured to receive a fifth message from the third device, where the fifth message is used for triggering or activating a second model of the target device, and the target model includes the second model.

Optionally, the processor 1810 is further configured to perform a model inference operation based on the second model.

Optionally, the second capability information includes at least one of the following:
model identity information of the model supported by the target device;
version information corresponding to the model supported by the target device; or
a security authentication certificate of the model supported by the target device, or token information indicating that the model supported by the target device succeeds in security authentication of the second device.

Optionally, the fifth message includes at least one of the following:
model identity information of the second model; or
version information of the second model.

Optionally, the receiving, by the radio frequency unit 1801, third information includes:
receiving the third information from the first device or the second device.

Optionally, before receiving the third information, the radio frequency unit 1801 is further configured to send first capability information to the third device, where the first capability information is used for indicating an AI capability of the target device.

The receiving, by the radio frequency unit 1801, third information includes:
receiving the third information from the third device or the second device, where the third information includes fifth information.

Optionally, the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

It can be understood that, for implementation processes of implementations in this embodiment, reference may be made to related descriptions in the embodiment of the information transmission method shown in FIG. 5, with the same or corresponding technical effects achieved. To avoid repetition, details are not described herein again.

In another implementation, the radio frequency unit 1801 is configured to send first capability information to a third device, where the first capability information is used for indicating an AI capability of a target device; and
the processor 1810 is configured to obtain a target model, where the target model includes a model applicable to the target device.

Optionally, the obtaining, by the processor 1810, a target model includes:
obtaining the target model from the third device through the radio frequency unit 1801.

Optionally, the obtaining, by the processor 1810, a target model includes:
obtaining the target model from a second device through the radio frequency unit 1801, where a model registered or published by the second device includes the target model.

Optionally, the obtaining, by the processor 1810, a target model includes:
receiving fifth information through the radio frequency unit 1801, where the fifth information includes at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

Optionally, the first capability information includes at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

It can be understood that, for implementation processes of implementations in this embodiment, reference may be made to related descriptions in the embodiment of the model determining method shown in FIG. 7, with the same or corresponding technical effects achieved. To avoid repetition, details are not described herein again.

An embodiment of this application further provides a network-side device, including a processor and a communication interface. The communication interface is coupled to the processor, and the processor is configured to run a program or instructions to implement the steps in the method embodiment shown in at least one of FIG. 2 to FIG. 8. The network-side device embodiment corresponds to the foregoing method embodiment for the network-side device, and all implementation processes and implementations of the foregoing method embodiment are applicable to the network-side device embodiment, with the same technical effects achieved.

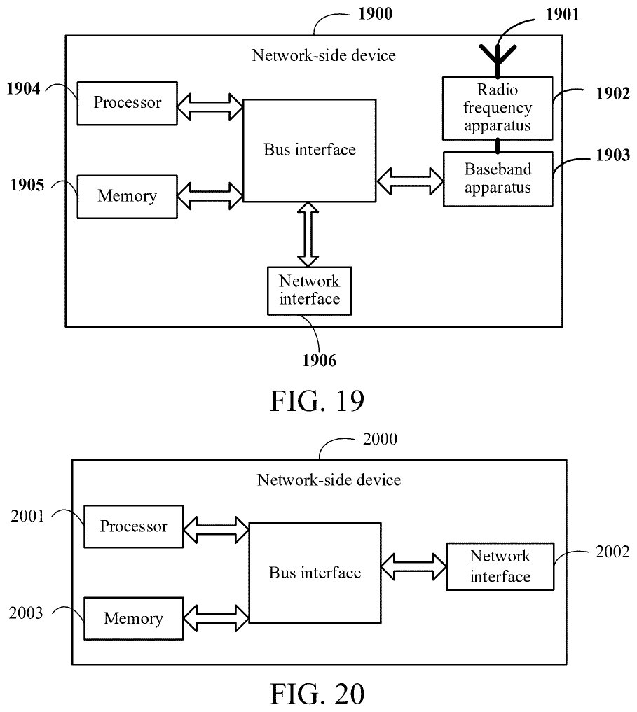

Specifically, an embodiment of this application further provides a network-side device. As shown in FIG. 19, the network-side device 1900 includes an antenna 1901, a radio frequency apparatus 1902, a baseband apparatus 1903, a processor 1904, and a memory 1905. The antenna 1901 is connected to the radio frequency apparatus 1902. In an uplink direction, the radio frequency apparatus 1902 receives information through the antenna 1901, and sends the received information to the baseband apparatus 1903 for processing. In a downlink direction, the baseband apparatus 1903 processes to-be-sent information, and sends the information to the radio frequency apparatus 1902; and the radio frequency apparatus 1902 processes the received information and then sends the information through the antenna 1901.

The methods performed by the network-side device in the foregoing embodiments may be implemented in the baseband apparatus 1903, and the baseband apparatus 1903 includes a baseband processor.

The baseband apparatus 1903 may include, for example, at least one baseband board, where a plurality of chips are disposed on the baseband board. As shown in FIG. 19, one of the chips is, for example, the baseband processor, which is connected to the memory 1905 through a bus interface, to invoke a program in the memory 1905 to perform the operations of the network device shown in the foregoing method embodiments.

The network-side device may further include a network interface 1906. The interface is, for example, a common public radio interface (CPRI).

Specifically, the network-side device 1900 in this embodiment of this application further includes instructions or a program stored in the memory 1905 and capable of running on the processor 1904, and the processor 1904 invokes the instructions or program in the memory 1905 to perform the method performed by the modules shown in at least one of FIG. 10 to FIG. 16, with the same technical effects achieved. To avoid repetition, details are not described herein again.

Specifically, an embodiment of this application further provides a network-side device. As shown in FIG. 20, the network-side device 2000 includes a processor 2001, a network interface 2002, and a memory 2003. The network interface 2002 is, for example, a common public radio interface (CPRI).

Specifically, the network-side device 2000 in this embodiment of this application further includes instructions or a program stored in the memory 2003 and capable of running on the processor 2001, and the processor 2001 invokes the instructions or program in the memory 2003 to perform the method performed by the modules shown in at least one of FIG. 10 to FIG. 16, with the same technical effects achieved. To avoid repetition, details are not described herein again.

An embodiment of this application further provides a readable storage medium. The readable storage medium stores a program or instructions. When the program or the instructions are executed by a processor, the processes of the method embodiment shown in at least one of FIG. 2 to FIG. 8 are implemented, with the same technical effects achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or a compact disc. In some examples, the readable storage medium may be a non-transitory readable storage medium.

An embodiment of this application further provides a chip. The chip includes a processor and a communication interface. The communication interface is coupled to the processor. The processor is configured to run a program or instructions, to implement the processes of the method embodiment shown in at least one of FIG. 2 to FIG. 8, with the same technical effects achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program/program product. The computer program/program product is stored in a storage medium. The computer program/program product is executed by at least one processor to implement the processes in the method embodiment shown in at least one of FIG. 2 to FIG. 8, with the same technical effects achieved. To avoid repetition, details are not described herein again.

An embodiment of this application further provides a communication system, including a first device, a second device, a third device, and a target device. The first device may be configured to perform the steps in the method embodiment shown in FIG. 3. The second device may be configured to perform the steps in the method embodiment shown in FIG. 2 or FIG. 8. The third device may be configured to perform the steps in the method embodiment shown in FIG. 4 or FIG. 6. The target device may be configured to perform the steps in the method embodiment shown in FIG. 5 or FIG. 7.

It should be noted that the terms “include”, “comprise”, or any of their variants in this specification are intended to cover a non-exclusive inclusion, so that a process, a method, an object, or an apparatus that includes a list of elements not only includes those elements but also includes other elements that are not expressly listed, or further includes elements inherent to such a process, method, object, or apparatus. Without more restrictions, an element defined by the statement “including a . . . ” does not preclude existence of other identical elements in a process, method, object, or apparatus that includes the element. In addition, it should be noted that the scope of the methods and the apparatuses in the implementations of this application is not limited to performing functions in the shown or described order, but may also include performing functions in a substantially simultaneous manner or in a reverse order depending on the functions involved. For example, the described methods may be performed in an order different from that described, and steps may be added, omitted or combined. In addition, features described with reference to some examples may be combined in other examples.

According to the foregoing descriptions of the implementations, a person skilled in the art may clearly understand that the methods in the foregoing embodiments may be implemented by a computer software product in combination with a required general-purpose hardware platform, or certainly may be implemented by hardware. The computer software product is stored in a storage medium (for example, a ROM, a RAM, a magnetic disk, or a compact disc), and includes several instructions for instructing a terminal or a network-side device to perform the methods described in the embodiments of this application.

The foregoing describes the embodiments of this application with reference to the accompanying drawings. However, this application is not limited to the foregoing specific implementations. The foregoing specific implementations are merely examples, but are not limitative.

What is claimed is:

1. An information transmission method, comprising:
receiving, by a second device, a first message from a first device, wherein the first message is used for registering or publishing a first model; and
sending, by the second device, a second message to the first device, wherein the second message is a response message for registering or publishing the first model, the second message carries first information, and the first information comprises at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

2. The method according to claim 1, wherein the first message carries second information, and the second information comprises at least one of the following:
attribute information of the first model;
file information of the first model; or
storage information of the first model.

3. The method according to claim 2, wherein the attribute information of the first model comprises at least one of the following:
version information of the first model;
parameter information of the first model;
an activation condition of the first model;
a function supported by the first model;
producer information of the first model; or
consumer information of the first model.

4. The method according to claim 1, wherein the method further comprises:
sending, by the second device, third information to a target device, wherein the third information comprises at least one of the following:
file information of a target model;
storage information of a target model;
model identity information, allocated by the second device, of a target model;
version information, allocated by the second device, of a target model;
second indication information, used for indicating that a target model succeeds in security authentication of the second device;
an activation condition of a target model; or
a security authentication certificate of a target model, or token information indicating that a target model succeeds in security authentication of the second device, wherein
the first model comprises the target model.

5. The method according to claim 4, wherein the method further comprises:
receiving, by the second device, a third message from a third device, wherein the third message comprises at least one of the following:
model identity information of the target model;
version information of the target model; or
a security authentication certificate of the target model, or token information indicating that the target model succeeds in security authentication of the second device; and
sending, by the second device, fourth information to the third device, wherein the fourth information comprises at least one of the following:
third indication information, used for indicating whether the target model succeeds in security authentication of the second device; or
the activation condition of the target model.

6. The method according to claim 4, wherein the method further comprises:
obtaining, by the second device, first capability information, wherein the first capability information is used for indicating an AI capability of the target device; and
determining, by the second device, the target model based on the first capability information and the second information;
wherein the obtaining, by the second device, first capability information comprises:
obtaining, by the second device, the first capability information from the third device;
wherein the first capability information comprises at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

7. The method according to claim 4, wherein before the sending, by the second device, third information to a target device, the method further comprises:
receiving, by the second device, seventh information from the third device, wherein the seventh information comprises the model identity information or the version information of the target model, and the seventh information is used for indicating the second device to send, to the target device, model file information or model storage information corresponding to the model identity information or the version information of the target model.

8. The method according to claim 1, wherein
the first device comprises at least one of a third-party service server, a service server in a network, a core network element in a network, a network management system device, a base station device, or a terminal device; or
the second device comprises a model publishing platform; or
the third device comprises a model management and control device; or
the target device comprises at least one of a network-side device and a terminal device.

9. An information transmission method, comprising:
sending, by a first device, a first message to a second device, wherein the first message is used for registering or publishing a first model; and
receiving, by the first device, a second message from the second device, wherein the second message is a response message for registering or publishing the first model, the second message carries first information, and the first information comprises at least one of the following:
first indication information, used for indicating whether the first model succeeds in security authentication of the second device;
a security authentication certificate of the first model, or token information indicating that the first model succeeds in security authentication of the second device;
model identity information, allocated by the second device, of the first model; or
version information, allocated by the second device, of the first model.

10. The method according to claim 9, wherein the first message carries second information, and the second information comprises at least one of the following:
attribute information of the first model;
file information of the first model; or
storage information of the first model.

11. The method according to claim 10, wherein the attribute information of the first model comprises at least one of the following:
version information of the first model;
parameter information of the first model;
an activation condition of the first model;
a function supported by the first model;
producer information of the first model; or
consumer information of the first model.

12. The method according to claim 9, wherein the method further comprises:
sending, by the first device, third information to a target device, wherein the third information comprises at least one of the following:
file information of a target model;
storage information of a target model;
model identity information, allocated by the second device, of a target model;
version information, allocated by the second device, of a target model;
second indication information, used for indicating that a target model succeeds in security authentication of the second device;
an activation condition of a target model; or
a security authentication certificate of a target model, or token information indicating that a target model succeeds in security authentication of the second device, wherein
the first model comprises the target model.

13. The method according to claim 12, wherein the sending, by the first device, third information to a target device comprises:
in a case that the first device determines, based on the first information, that the target model succeeds in security authentication of the second device, sending, by the first device, the third information to the target device;
wherein before the sending, by the first device, third information to a target device, the method further comprises:
receiving, by the first device, a fourth message from the target device, wherein the fourth message is used for requesting a model on the first device, and the model on the first device comprises the target model.

14. A model determining method, comprising:
sending, by a target device, first capability information to a third device, wherein the first capability information is used for indicating an AI capability of the target device; and
obtaining, by the target device, a target model, wherein the target model comprises a model applicable to the target device.

15. The method according to claim 14, wherein the obtaining, by the target device, a target model comprises:
obtaining, by the target device, the target model from the third device.

16. The method according to claim 14, wherein the obtaining, by the target device, a target model comprises:
obtaining, by the target device, the target model from a second device, wherein a model registered or published by the second device comprises the target model.

17. The method according to claim 14, wherein the obtaining, by the target device, a target model comprises:
receiving, by the target device, fifth information, wherein the fifth information comprises at least one of the following:
file information of the target model;
storage information of the target model;
model identity information, allocated by the second device, of the target model;
version information, allocated by the second device, of the target model;
an activation condition of the target model;
second indication information, used for indicating that the target model succeeds in security authentication of the second device; or
a security authentication certificate of the target model, or token information indicating that the target model succeeds in security authentication of the second device.

18. The method according to claim 14, wherein the first capability information comprises at least one of the following:
fourth indication information, used for indicating whether the target device supports a model-based AI functionality;
an AI functionality type supported by the target device;
functionality identity information of an AI functionality supported by the target device; or
an applicable condition of each AI functionality supported by the target device.

19. A communication device, comprising a processor and a memory, wherein the memory stores a program or instructions capable of running on the processor, and when the program or the instructions are executed by the processor, the steps of the information transmission method according to claim 1 are implemented.

20. A non-transitory readable storage medium, wherein the non-transitory readable storage medium stores a program or instructions, and when the program or the instructions are executed by a processor, the steps of the information transmission method according to claim 1 are implemented.
